(19) United States
(12) Patent Application Publication
(10) Pub. No.: US 2009/0295300 A1
(43) Pub. Date: Dec. 3, 2009

(54) METHODS AND APPARATUS FOR A DIMMABLE BALLAST FOR USE WITH LED BASED LIGHT SOURCES

(75) Inventor: Ray James King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PureSpectrum, Inc

(21) Appl. No.: 12/537,464

(22) Filed: Aug. 7, 2009

Related U.S. Application Data
(63) Continuation-in-part of application No. 12/277,014, filed on Nov. 24, 2008.
Application No. 12/277,014 is a continuation-in-part of application No. 12/187,139, filed on Aug. 6, 2008.
Application No. 12/187,139 is a continuation-in-part of application No. 12/178,397, filed on Jul. 23, 2008.
(60) Provisional application No. 61/006,965, filed on Feb. 8, 2008.

(51) Int. Cl. H05B 41/36

(52) U.S. Cl. 315/209 R

(57) ABSTRACT

Methods and apparatus for powering a dimmable ballast operating with LED light source(s) are provided. In one embodiment, the ballast circuit includes sections comprising: power input, full wave bridge rectifier, voltage regulator, integrated circuit driver, switching transistors, bypass capacitor, resonant circuit, rectifier diodes, and an LED light source. The resonant circuit receives energy from the voltage source and the bypass capacitor every switching cycle, and provides current to the rectifier diodes and one or more LEDs for generating light. Further, because the current flowing into the resonant circuit is substantially sinusoidal and in line with the input voltage, the circuit exhibits a desirable power factor. The ballast circuit can also effectively dimmed over a wide range using a phase angle dimmer, allowing further energy savings.

### RELATED APPLICATIONS

This application is a continuation-in-part of U.S. patent application Ser. No. 12/277,014 filed on Nov. 24, 2008, which is a continuation-in-part of U.S. patent application Ser. No. 12/187,139 filed Aug. 6, 2008, which is a continuation-in-part of U.S. patent application Ser. No. 12/178,397 filed on Jul. 23, 2008, which in turn claims the benefit under 35 U.S.C. § 119(e) to U.S. (Provisional) Patent Application entitled “Dimmable Ballast with High Power Factor” filed on Feb. 8, 2008, Ser. No. 61/006,965, the contents of which are herein incorporated by reference for all that each teaches.

### FIELD OF THE DISCLOSURE

The present disclosure relates generally to electronic lighting ballasts and, more particularly, to methods and apparatus for high efficiency ballasts for use with light emitting diode (“LED”) based light sources that can be effectively dimmed and configured to operate with a high power factor.

### BACKGROUND

In the field of lighting, LEDs are emerging as a promising technology for generating light at high efficiency. Traditionally, LEDs have been used in consumer electronics as indicators (such as function indicators, power indicators, etc.). The development of LEDs that generate white light (as opposed to LEDs that produced red, green, or other light colors) allows LEDs to be used as potential general purpose lighting sources. While LEDs provide a relatively high lumens/watt, they are presently limited in the amount of power that can be converted into light. Unlike incandescent bulbs which convert very little of the input energy into light (about 90% of the energy input into an incandescent light bulb is used to generate heat), LEDs convert a high percentage of input power into light. Further, unlike fluorescent lamps and other forms of gas-discharge lamps, LEDs are solid state devices and do not rely on a glass or quartz bulb to contain gases (which often contain hazardous materials such as mercury) that are ionized. Finally, LEDs are individually smaller and more reliable than bulbs.

Traditionally, LEDs were limited in the power they could dissipate and many LEDs are still designed for relatively low power (conventional LEDs draw only 20 milli-amps and are rated at only 1/10 watt). Indeed, the prior development and incorporation of LEDs in many battery operated devices was based on their low power consumption, and hence their low power levels were not considered a limiting aspect, but a desirable aspect. However, recent advances to adapt LEDs as light sources have resulted in development of relatively high powered LEDs. A high power LED may be considered an LED capable of handling at least ½ watt, but LEDs are presently available that consume 6 or more watts of power. In comparison, a typical incandescent bulb is rated at 60-100 watts (with higher wattages readily available), and a compact fluorescent bulb is typically rated between 11 and 40 watts. These ranges are not absolute values, but represent typical ranges. Thus, while an LED maybe more efficient than an incandescent or fluorescent bulb in generating light, the total light output of a single LED is typically less than conventional light sources. In summary, while conventional light sources can handle greater amounts of power than individual LED light sources, they are less efficient.

Two approaches for providing more light using LEDs are possible. First, LEDs are available (and likely will be developed) to handle greater power, therefore each can individually generate more light than conventional LEDs. Second, a plurality of conventional LEDs can be used to function as a single light source. In the latter case, LED lighting panels or strips are commercially available that can comprise hundreds of LEDs functioning as a single light source.

LEDs are a form of diode and operate on a DC current. Typically, the voltage across an individual LED is relatively low, typically only several volts. It is well known that a simple circuit for limiting direct current in an LED can comprise a current limiting resistor connected to a DC voltage source that passes current through an LED. These circuits are relatively simple, but have the disadvantage that the resistor is a passive element and any energy dissipated through it is energy that is not converted into useful light. Hence, such systems are not energy efficient.

If LEDs are to become viable substitutes for conventional light sources (incandescent or gas-discharge bulbs), it would be desirable to be able to dim the LEDs. Various lighting applications require, or benefit from, dimming light sources. For example, to become a viable replacement for incandescent bulbs in certain residential applications, market requirements would dictate that LEDs be dimmable. In other applications, including so-called “daylight harvesting” applications, energy savings is achieved by dimming lights based on ambient lighting conditions. Thus, if natural daylight is sufficient in the desired area, the lighting source may be automatically dimmed. If natural daylight is insufficient, then the lighting levels are increased. This application is common in security lighting and energy savings applications.

Consequently, circuitry for controlling LED light sources in lighting applications requires an energy efficient circuit for providing current to one or more LEDs, but at the same time should provide dimming capability and efficient operation.

In addition, because conventional lighting frequently operates on household AC voltage, the control circuitry for LEDs should be able to operate using household power (e.g., 120 volts and 60 Hertz in the U.S., 240 volts and 50 Hertz in many other countries). This requires circuitry for converting AC to a lower level DC voltage. Again, this circuitry should be energy efficient, and should be compatible with dimming circuits.

However, a problem can arise when using conventional dimmers in certain type of lighting circuits. While many prior art dimmers operate fine with incandescent lamps having a minimum wattage, operating the same dimmers with ballasts can be problematic. Some dimmers state that 20 to 40 watts are required as a minimum load, and hence do not operate properly with lower rated loads. Because LEDs typically have a high efficiency and present a lower load (frequently less than 20 or 40 watts), LED light sources may not meet the minimum power required by a conventional dimmer. Other dimmers do not have this requirement, but they are more complex (and hence more costly). In other instances, ballasts for controlling a LED light source may require specially designed dimmers, which cannot be used with other lighting fixtures.

The ballast (e.g., the circuitry for controlling current through the LED) should also provide a favorable power factor (“pf”). The power factor has a range of between 0 and 1 and is generally defined as the relationship of the real power to the apparent power. In an electric power system, a load with low power factor draws more current than a load with a high power factor for the same amount of useful power transferred to the load. The higher current increases the energy lost in the distribution system, and requires at an aggregate level larger distribution wires and equipment by the distribution system. Because of the costs of larger equipment and wasted energy, electrical utilities will usually charge a higher rate to industrial or commercial customers having a low power factor. In summary, a low power factor in the lighting ballast causes inefficiency in the power distribution system and is undesirable.

An incandescent bulb typically has a very high power factor (better than pf=0.9), and is desirable in this respect. However, as noted, incandescent bulbs are not very efficient in converting incoming power into light. While gas-discharge lights such as fluorescent bulbs, are more efficient, the circuitry used to drive the bulb typically have a lower power factor (0.5-0.7). In this regard, they are undesirable. Thus, it would be desirable to have LEDs (which are very efficient) to have a high power factor. It is commonly accepted that for loads less than 100 watts, a high power factor is pf=0.9 or higher. For loads greater than 100 watts, a high power factor is p=0.95 or greater. Because LEDs are relatively low power, typically the former classification is used (e.g., a high power factor is pf=0.9 or higher).

Further, there is a practical benefit to having a ballast that can be easily and reliably manufactured using few parts than other ballasts, and which can be easily adapted for not only gas-discharge lamps, but also for use with LED light sources.

Therefore, there is a need for circuitry for controlling one or more LEDs that is energy efficient, allows dimming of the LEDs, and maintains a high power factor.

### SUMMARY

Methods and apparatus are disclosed for dimmable ballast circuits that operate with LED light sources. In one embodiment, a dimmable ballast circuit receives alternating voltage from a power source and provides rectified line voltage to a first node and a second node, wherein the power source provides a current alternating at a line frequency. The first node and the second node are connected to each other via a bypass capacitor that presents high impedance at the line frequency. The bypass capacitor filters high frequency noise and stores high frequency energy in order to provide current at a switching (high) frequency when discharged. Typically, the switching frequency is at least two orders of magnitude higher than the line frequency. This capacitor is small enough in capacitance value relative to the load and line operating frequency that it provides a relatively large reactance to the rectified AC input from the power source at the line frequency. A first switch is operable to selectively couple the first node where the rectified line voltage is provided to a resonant circuit. The resonant circuit has a resonant frequency and stores energy during a portion of the switching cycle thereby generating a voltage across a diode bridge to which a LED light source is connected. Once the threshold voltage of the LED light source is exceeded, current flows through the LED, and light is emitted. In one embodiment, a second switch is operable to selectively couple the resonant circuit to the second node while the first switch is opened. This allows energy stored in the resonant circuit to be substantially recycled within the resonant circuit to also generate light.

### BRIEF DESCRIPTION OF THE DRAWINGS

FIGS. 1a and 1b illustrate one embodiment of a lighting ballast for a single LED.

FIGS. 2a-2c illustrate voltage waveforms present in the lighting ballast of FIG. 1.

FIGS. 3a and 3b are current flow diagrams illustrating operation of the lighting ballast.

FIG. 4 is another embodiment of a tank circuit for a lighting ballast using an LED.

FIG. 5 illustrates another embodiment of a tank circuit for a lighting ballast using a single LED.

FIGS. 6a and 6b illustrate voltage waveforms present in the tank circuit of one embodiment of a LED lighting ballast.

FIG. 7 illustrates another embodiment of a tank circuit of a lighting ballast using LEDs.

FIG. 8 illustrates another embodiment of a tank circuit for a lighting ballast using multiple LEDs and a starting capacitor.

FIG. 9 illustrates another embodiment of a voltage regulator of the lighting ballast of FIG. 1.

FIGS. 10a-10b illustrates waveform associated with a ballast used with a phase control dimmer.

FIG. 11 illustrates another embodiment of a tank circuit for a LED lighting ballast incorporating a center tap transformer.

FIG. 12 illustrates another embodiment of a tank circuit in a LED lighting ballast incorporating a synchronous rectifier.

FIG. 13 illustrates another embodiment of a tank circuit incorporating a current doubler in a LED lighting ballast.

FIG. 14 illustrates another embodiment of a tank circuit involving two LEDs in a “back-to-back” configuration.

### DETAILED DESCRIPTION

Methods and apparatus for dimmable ballasts for use with one or more LED are described herein. In the described examples, a dimmable ballast circuit, typically having a high power factor, is described that interfaces a power source with a light source comprising one or more LEDs. The disclosed dimmable ballasts include a high frequency filter capacitor to reduce high frequency energy from entering the power supply during its operation, allow operation of the ballast, and increase the efficiency of the ballast.

### Ballast Structure

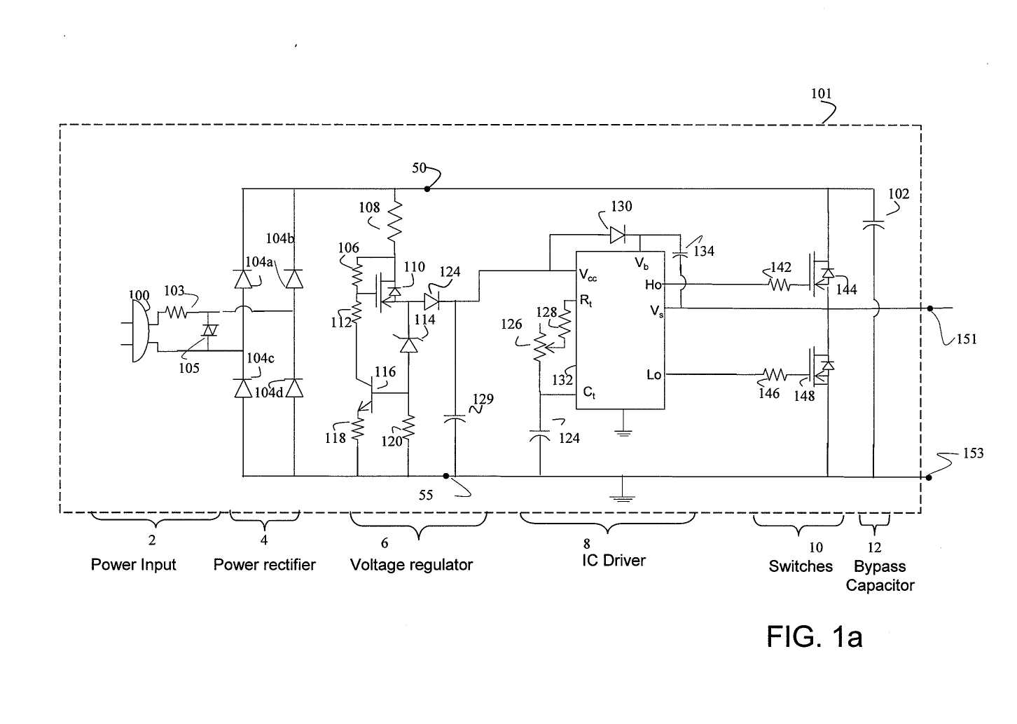

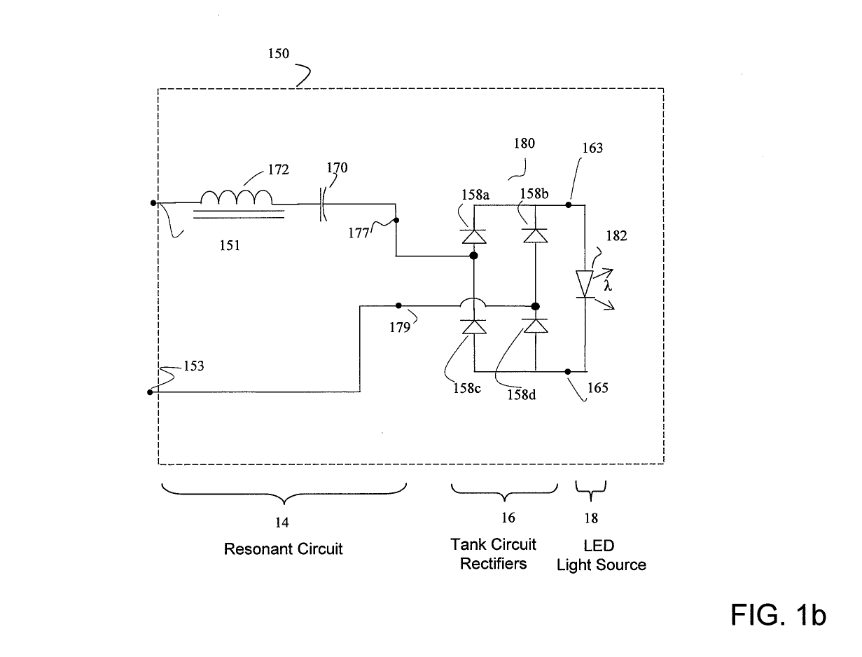

FIGS. 1a and 1b together illustrate one embodiment of an electrical lighting ballast capable of operating on household power, which typically in the U.S. is 120 VAC/60 Hz. Other countries may operate using 240 VAC/50 Hz and suitable changes in the component values may be necessary and are within the knowledge of one of ordinary skill in the art. Although various embodiments herein are disclosed in terms of “household voltage,” or “household power,” these terms refer to any readily available line voltage at a line frequency, and does not preclude application to other commercial or industrial power sources. Thus, for example, the principles of the present invention could be adapted to other voltages and frequencies, such as the 400 Hz AC systems used in commercial aircraft. Hence, variations regarding the power source characteristics are possible, which may impact the precise values of various components used.

The embodiment of FIGS. 1a and 1b can be divided at a high level into different sections. These sections include as shown in FIG. 1a: power input 2, power rectifier (a.k.a. “full wave bridge rectifier” or simply “rectifier”) 4, voltage regulator 6, integrated circuit (IC) driver 8, switching transistors (a.k.a. “switches” or “switching” section) 10, bypass capacitor 12, resonant circuit 14, tank circuit rectifier (a.k.a. “diode rectifiers”) 16, and light source 18. Further, the power input, rectifier, voltage regulator, IC driver, switching transistors, and bypass capacitor can be referred to as the main portion 101 of the ballast shown in FIG. 1a by a dotted line. The resonant circuit portion, tank circuit rectifier and light source can be referred to as the tank portion 150 shown in FIG. 1b in the dotted line. Together, these sections comprise the ballast. Although certain individual components in a section could be classified as being in an adjacent section instead, or considered as parts of two sections, this high level description of the sections is useful to explain operation of the ballast.

Typically, the light source will be integrated in a non-user removable manner with the ballast and can be considered as part of the ballast. LEDs typically have a long life and are not expected to require replacement, but it is possible that in some embodiment, the LEDs (or the ballast) could be replaced separately from the light source. In other contexts herein, the ballast may be described as being the circuitry for providing current to the light source, and thus excludes the LED(s). However, whether the LED is considered part of the ballast as used herein will be clear from the context, or in many cases, is not material to the explanation of the operation of the present invention.

### Power Input Section

The first section discussed is the power input section 2 in FIG. 1a that comprises a plug 100 for receiving household power, typically 120 volts in the U.S. and at a line frequency, typically 60 Hz. A filter resistor 103 typically around 3-12 ohms may be present along with a surge suppressor 105 as well as a fusible link (not shown). These components are often present in a commercial embodiment of the invention, but are not always present in all embodiments. These components serve in part to filter noise present in the ballast from being introduced back into the power line. Resistor 103 may aid in suppressing “ringing” energy caused by ringing line currents when the ballast is used in conjunction with a dimmer. This will be discussed further below.

During operation, the power input section essentially receives and provides 120 VAC at a 60 Hz line frequency from a power source (usually obtain by a receptacle or otherwise wired to a power distribution point in a building) to the input of the power rectifier section 4. The filter components aid in reducing noise from being introduced into the power line from the remainder of the ballast, and provide safety mechanisms to limit potential damage from high current or voltage.

### Power Rectifier Section

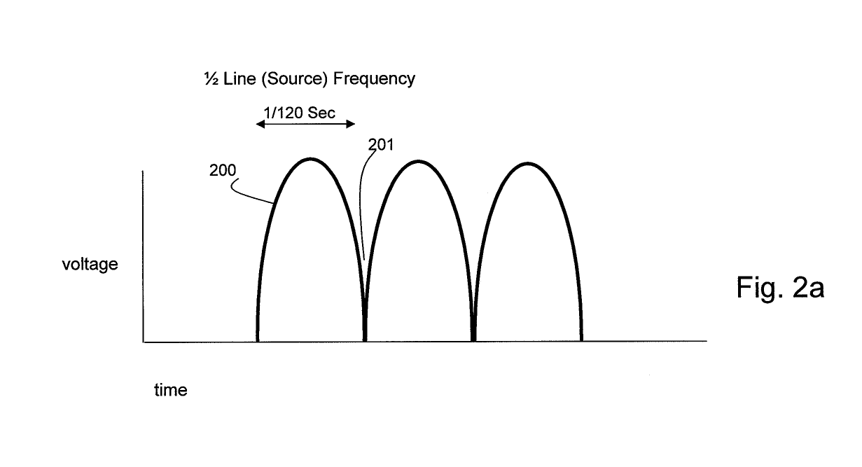

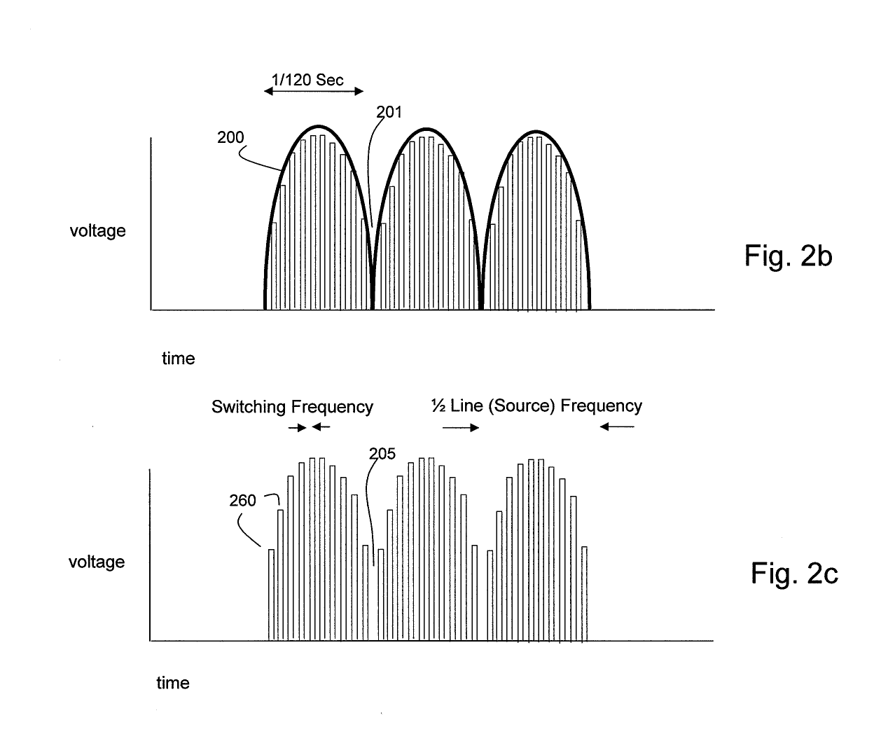

The input AC voltage from the power input section is provided to the rectifier section 4. The rectifier comprises a full wave bridge diode assembly comprising diodes 104a-104d rectifying the AC voltage to produce an unfiltered rectified DC voltage. These diodes can comprise 1 amp, 400 v 1N4001 diodes, although other embodiments can utilize a full wave bridge in the form of a single component. Unlike prior art ballasts which often incorporate a “smoothing” capacitor in the form of an electrolytic capacitor, the embodiment in FIG. 1a does not incorporate a smoothing capacitor to minimize the voltage drops that occur every half cycle at the line frequency of the rectified AC voltage. Thus, the full wave bridge produces a rectified AC voltage, which is a time varying DC voltage having a half sine wave shape as shown by line 200 in FIG. 2a. The DC voltage has a periodic waveform that repeats at twice the line frequency (e.g., 120 Hz). Thus, the DC voltage waveform repeats its shape every 1/120 of a second, which is one-half of the line period (60 Hz). The rectified AC voltage is the voltage present across the output of the full wave bridge, which is represented by nodes 50 and 55.

The voltage waveform of FIG. 2a shows a plurality of low points or “valleys” 201 where the rectified AC voltage drops to zero or near zero. These points coincide in time with the AC voltage crossing the zero voltage point at the input power section. Although voltage in the valley may not be exactly zero, the rectified AC voltage usually drops to less than 15% of the peak voltage, and often to zero volts. Thus, although the valley may not be zero volts, it is typically less than 18 volts when operating on 120 volts. Typically, other prior art lighting ballasts may incorporate a “smoothing” capacitor to filter the 120 Hz voltage so as to minimize ripple in the rectified voltage and to increase the power factor. Thus, in the prior art, the existence of such valleys is not desirable, and electrolytic storage capacitors are used to avoid such conditions. However, as it will be seen, such electrolytic storage capacitors are not required in the present invention, and in contrast to the prior art, if incorporated into the ballast shown in FIG. 1a across the output of the full wave bridge, would be adverse to the efficiency of the illustrated embodiment.

### Voltage Regulator Section

The ballast circuit also includes a voltage regulator section 6. This is sometimes referred to as a housekeeping supply circuit since it provides power necessary to maintain operation of the IC driver chip 132. The voltage regulator is connected to node 50 and 55, and receives power from the output of the full wave bridge. Voltage regulator 6 generates a substantially constant voltage that exceeds a minimum threshold (e.g., 10 volts, etc.) to provide power to the integrated circuit driver 132. Because the voltage at nodes 50, 55 is not filtered by a smoothing capacitor, a regulator is required to provide a steady input voltage to the driver. Recall that the voltage waveform from the rectifier section 4 has at each half cycle a “valley” wherein the voltage drops to zero or near-zero, albeit for a short time. If the voltage to the IC were to fall to zero (or near zero) volts during this time, the driver chip may cease to function. In certain cases, there may be sufficient charge stored in the IC itself to overcome these brief valleys in the supply voltage. However, when using the ballast with a dimmer, the period which the input voltage is zero increases in duration, and the IC would be unable to continue functioning. Thus, a voltage regulator is incorporated.

In the illustrated embodiment, voltage regulator section 6 is implemented using an NMOS transistor 110 that is connected to the first node 50 via a resistor 108, which in one embodiment is 220 ohms. The drain of NMOS transistor 110 is connected to its respective gate via a resistor 106, which in one embodiment is 1M ohms. The gate of NMOS transistor 110 is further connected to a collector of a transistor 116 via an optional resistor 112, which in one embodiment is 1 k ohms, which has its respective base connected to the anode of a zener diode 114, which in one embodiment is a 14 v zener diode. Resistor 112 reduces the gain of the transistor thereby reducing possibility of oscillations in transistor 110. The cathode of zener diode 114 is connected to the source of NMOS transistor 110.

In addition, the base of transistor 116 is connected to second node 55 via resistor 120 which is one embodiment is a 10 k ohms, and its emitter is connected to the second node 55 via a resistor 118, which in one embodiment is 1 k ohms. In the example of FIG. 1a, the source of the NMOS transistor 110 is connected to the anode of a diode 124 and the cathode of diode 124 is connected to the second node 55 via an energy storage device, such as a capacitor 129 (referred to herein as a housekeeping filter capacitor) which in this embodiment can be 33 μF. As will be described below, capacitor 129 stores energy therein to aid in providing a substantially constant voltage to the IC driver 132, particularly in conjunction with operation of a phase control dimmer. The capacitor 129 assists diode 130 in charging capacitor 134, which in this embodiment is 1 μF, also called bootstrap charging capacitor. Thus, capacitor 129 also functions in conjunction with the driver 132, but is shown as a component of voltage regulator section 6 for illustration's sake.

Referring to the IC driver 132, voltage regulator section 6 provides the substantially constant (i.e., regulated) voltage via diode 124, which also isolates voltage regulator 6 from driver 132. Stated differently, diode 124 prevents current from flowing from capacitor 129 into regulator 6 when the voltage of the first node 50 falls below the voltage stored in capacitor 129. In the embodiment of FIG. 1a, capacitor 129 and the cathode of diode 124 are also connected to the supply voltage (Vcc) of driver circuit 132 to provide a substantially constant voltage to driver circuit 132. The value of the capacitor 129 may be sized so as to allow operation with a dimmer, such as a phase control dimmer, which may limit the average voltage provided to the rectifier during dimming, and therefore to the ballast. Thus, even if a dimmer is reducing the average input voltage by preventing the input voltage wave form from being provided to the ballast for a certain time period each half cycle, the capacitor must be sized to provide sufficient power to the IC driver to allow it to continue operate through the range of dimming. The capacitor 129 and the cathode of the diode 124 are also connected to the anode of a diode 130, which is connected to the high side floating supply voltage (V_{B}) of the driver circuit 132 via its respective cathode. Further, the cathode of the diode 130 is connected the high side floating supply offset voltage (Vs) of the driver circuit 132 via a capacitor 134. This capacitor supplies the driver power for the switching FET 144.

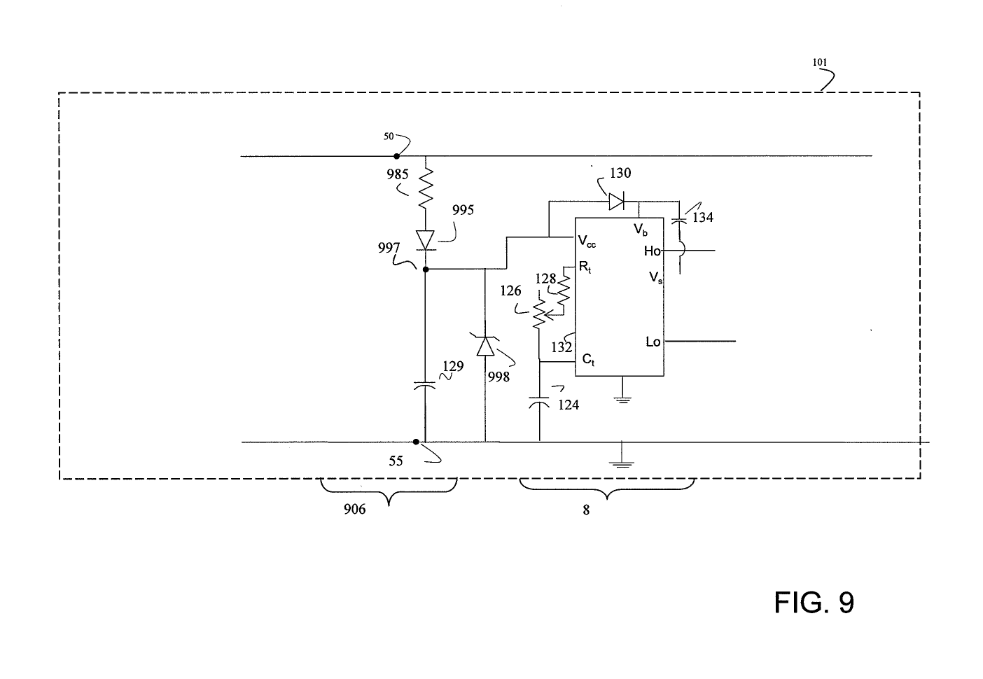

An alternate embodiment of the voltage regulator section 6 is possible. One alternative embodiment that can be used if the ballast is not to be dimmed is shown in FIG. 9. In FIG. 9, voltage regulator section 906 is shown, and comprises resistor 985, diode 995, and capacitor 129. In this embodiment, a current flowing through resistor 985 charges capacitor 129 when the voltage at node 50 is sufficient to do so. When the voltage at node 50 is less than the required Vcc voltage, the capacitor 129 discharges, providing the necessary voltage to drive the IC driver 132 in the IC driver section 8. Diode 995 prevents the energy from the capacitor form being provided back to node 50. In this embodiment, the resistor is typically a 47 k-90K ohm value and provides a sufficient average voltage to the driver circuit 132. The zener diode 998 may be incorporated for providing overvoltage protection to the Vcc input voltage of the integrated circuit. In some embodiments, the integrated circuit may incorporate such protection internally.

This arrangement requires fewer parts for the voltage regulator embodiment of FIG. 1a, but is less efficient. However, the energy lost is relatively minimal in terms of absolute power compared to other light sources since the LED is a relatively low power light source. Thus, this embodiment may be used where the ballast is not being dimmed. If however, the ballast is being used with a dimmer, then this voltage regulator embodiment in FIG. 9 may not be sufficient to maintain voltage to the IC 132. Specifically, if the dimmer is a phase angle dimmer and is dimmed to a low level, then the average output voltage at node 50 is very low. As the firing angle of the phase angle dimmer increases, the average output voltage of the dimmer (and hence the average voltage present at node 50) decreases. Specifically, there would be a large percentage during the half cycle of the line voltage when there is no voltage present. Capacitor 129 may be insufficient for providing power to the IC 132 during this time, nor may the capacitor be able to fully charge during the portion when the dimmer does allow line voltage to appear at node 50.

### IC Driver Section

The driver circuit 132 is configured to generate a signal that alternately actuates one of the transistors 144 and 148 at the switching frequency, which is much higher than the line frequency. In particular, during the first half (or a portion thereof) of a single cycle of the switching frequency, the high side output (HO) of the driver circuit 132 produces a high side pulse to turn on transistor 144 while transistor 148 is turned off. Typically, the high side pulse has a duration that does not exceed half of the time period of a cycle of the switching frequency. When the driver circuit 132 turns on transistor 144, the transistor 144 couples the node 50 to the resonant circuit 245 via a low impedance path.

Typically the switching frequency is 20 kHz or higher, and it is typically at least two orders of magnitude greater than the line frequency. Thus, reference herein to the “low frequency” refers to the line frequency, whereas reference to the “high frequency” refers to the switching frequency. In certain embodiments, the driver IC may be an International Rectifier® IR2153 self Oscillation Half-Bridge Driver integrated circuit. In other embodiments, a 555 timer IC or other pulse width generator circuit (including processor based) may be used to generate the signals for driving the switching transistors in switching section 10.

In the illustrated embodiment of FIG. 1a, the driver circuit 132 operates continuously at a fixed frequency that is determined by selecting different resistance 126,128 and capacitance 124 values. Typically, the switching frequency is determined during manufacturing of the ballast, and is not user settable. In certain embodiments, the user may be able to vary resistor 126 by turning a potentiometer integrated into the ballast as a mechanism to dim the ballast in a limited manner, although this is not as efficient as using the phase controlled dimmer subsequently discussed. More particularly, the oscillating timing capacitor input (C_{T}) of the driver circuit 132 is connected to the second node 55 via a capacitor 124, which in one embodiment is 220 pF. Further, the oscillator timing resistor input (R_{T}) of the driver circuit 132 is connected to the oscillating timing capacitor input (C_{T}) of the driver circuit 132 via an adjustable resistor 126 or impedance (e.g., a potentiometer, a transistor presenting a variable resistance or impedance, etc.), which in one embodiment is 50 k. In such a configuration, the switching frequency of driver circuit 132 can be variably controlled by adjusting the resistance of resistor 126. This value may be set during manufacturing to determine the operation frequency, in order to accommodate other components with varying parameter ranges (such the inductor or capacitor in the tank circuit). In other embodiments, a fixed resistance value for resistor 126 can be used. The presence of resistor 128, which in one embodiment is 47-33K ohms, which is optional, ensures that a setting of a zero resistance at resistor 126 does not accidently occur.

In the illustrated example, the resistance value of the resistor 126 and the capacitance value of the capacitor 124 configure the driver circuit 132 to produce pulses at a frequency in the range of approximately 20 to 100 KHz. Specifically, the pulses are alternately produced by driver circuit 132 and are output via the high side gate driver output (HO) and the low side gate driver output (LO). Stated differently, during the first half cycle of a period of the switching frequency (i.e., the half of the time period for a single switching cycle), the high side gate driver output of the driver circuit 132 produces a pulse. During the second half cycle of the period (i.e., the low side of the cycle) of the switching frequency, the low side gate driver output of the driver circuit produces a pulse. Typically, there is a dead time between pulses when neither transistor is turned on, e.g., the time after the first pulse ends and before the second pulse begins.

In the embodiment of FIG. 1a, the high side gate driver output (HO) is further connected to the switching section 10. Specifically, it is connected to the gate of NMOS transistor 144 and the low side gate driver output (LO) is connected to the gate of NMOS transistor 148. In other examples, driver circuit 132 may be connected to the gates of transistors via resistors 142 or 146, which in one embodiment are 31 ohms, to prevent parasitic oscillations, for example. NMOS transistors 144 and 146 are also connected to the high voltage floating supply return (Vs) of the driver circuit 132 via their source and drain, respectively. The drain of NMOS transistor 144 is connected to the first node 50 and the source of NMOS transistor 148 is connected to the second node 55. The supply voltage Vcc is also provided to diode 130, which is a fast recovery diode, and to capacitor 134 which is a supply source for the Ho gate drivers.

### Switching Section

The switching section 10 comprises transistors 144 and 148 and are typically both implemented using vertical N-Channel metal oxide semiconductor (NMOS) field effect transistors, although one of ordinary skill in the art would know that these transistors can be implemented by any other suitable solid state switching device (e.g., a P-channel metal oxide field effect transistor, an insulated gate bipolar transistor (IGBT), a lateral N-channel mode MOS transistor, a bipolar transistors, a thyristor, gate turn off (GTO) device, etc.).

The IC driver 8 and switching section 10 form a half-bridge switching topology that is implemented to provide energy at output nodes 151 and 153, which in turn provide power to the resonant circuit portion 14 of “tank circuit” 150. It is desirable that the transistors switch at a zero-current or zero voltage condition so as to minimize the stress on the components, which impacts their longevity, and also the efficiency.

To form the half-bridge topology, the drain of the first transistor 144 is connected to the first node 50 and the source of the second transistor 148 is connected to the second node 55. Thus, the voltage present on node 50 and the drain of the first transistor 144 is the rectified voltage waveform 200 shown in FIG. 2a. The gates of the transistors 144 and 148 are both connected to first and second outputs of the driver 132, respectively, and the source of the transistor 144 is connected to the drain of the transistor 148, both of which are also connected to the resonant circuit 132. The transistor 144 switches the voltage from node 50 at a high frequency producing the square wave shown in FIG. 2c. Because the resulting voltage at node 151 is a high frequency square wave that follows the line frequency, FIG. 2b shows the rectified voltage at node 50 over-laid with the square waves shown in FIG. 2c to illustrate that the high frequency square wave is limited by the rectified AC voltage. Note that FIG. 2b illustrates the aforementioned “valleys” 201 in the envelope waveform having a period of twice the line frequency. This is also present as valley 205 in FIG. 2c

The nodes 151 and 153 represent the output of the switching section. Thus, the square waves 260 of FIG. 2c are present at the output of the switching section and provided as input to the tank circuit section of FIG. 1b.

### Bypass Capacitor Section

The final portion of the main ballast portion 150 is the bypass capacitor portion 12. This section comprises a single capacitor, termed the “bypass capacitor” herein, that is connected to nodes 50 and 55; specifically, across the outputs of the full wave bridge. Thus, the voltage present at the output of the full wave bridge section 2 is the same voltage across the terminals of the bypass capacitor. The bypass capacitor is a high frequency energy storage device, such as a polypropylene capacitor 102. It is typically not an electrolytic capacitor, since these are typically unsuitable for high-frequency operation. The bypass capacitor should not be confused with a “smoothing” electrolytic capacitor similarly positioned across the output of a full wave bridge rectifier in found the prior art, but which performs a different function. In the example of FIG. 1a, the capacitance value of the capacitor 102 is selected to have a large reactance to the rectified voltage at the line frequency (60 Hz).

The reactance is defined by the following formula in Equation 1:

$$Xc = \frac{1}{2 π fC} \qquad Eq . 1$$

In the case for a ballast operating at a switching frequency of 40 kHz, a 1 μF capacitor typically used and would present an reactance of about 4 ohms. However, this same capacitor would have a reactance at the line frequency of 60 Hz of about 2653 ohms. The line frequency (60 Hz) is generally fixed by the power source provider and thus a high impedance is presented by the bypass capacitor at the line frequency, typically greater than 1500 ohms. In regard to the switching frequency, because there is a range of the switching frequency that can vary in different embodiments (typically ranging from 18 kHz to 100 kHz), the impedance of the bypass capacitor at the high switching frequency can vary in proportion to the switching frequency. For example, at 80 kHz the impedance of the same 1 μF bypass capacitor would be 2 ohms. Typically, the impedance of the bypass capacitor at the operating switching frequency is typically less than 100 ohms.

Thus, the bypass capacitor does not substantially affect the rectified AC voltage provided via rectifier section 4 during operation of the ballast. The bypass capacitor present a high impedance to the rectified AC input which results in the AC current being distributed symmetrically on the rising and falling edges of the rectified AC voltage. In other words, the bypass capacitor causes the load current from the AC line to be sinusoidal to the load, thereby causing the load current to track the rectified AC voltage, which results in a high power factor. The tank circuit particularly, the inductor, is characterized to follow the rising and falling of the rectified AC voltage and thus present a sinusoidal current to the light source. The use of a high frequency, small value, non-electrolytic bypass capacitor is in distinction to the prior art that uses a low frequency, large value, electrolytic capacitor across the output of the rectifier to filter out the 120 Hz AC ripple due to the line frequency in order to remove the “valleys” in the rectifier output. The capacitance value of capacitor 102 in the embodiment of FIG. 1a is selected to store high frequency energy, generally in the kilohertz (20-80 kHz) range. As such, capacitor 102 typically has a value of approximately 0.033 to 1 microfarad (μF) depending on the power output of the ballast, which in this embodiment is approximately 1 to 15 watts. The bypass capacitor is made of any suitable material (e.g., polypropylene, etc.) for a ballast having the required power output. Stated in more general terms, capacitor 102 generally has a capacitance value in the range of 2 to 120 nanofarads (nF) per watt of power of the output LED(s), and typically around 50 nF/watt when 120 VAC is used. If 240 VAC is used, then the capacitance value is half the above. Because the capacitor 102 is typically a polypropylene capacitor, it has a lifespan much greater than larger electrolytic capacitors that typically are used in conventional ballasts (albeit for a different function).

The value of capacitor 102 can be around 0.22 μF for a 5 watt light source. The value can be adjusted as appropriate for the output load, but typically is 1 μF or less for a typical LED based light source that is less than 15 watts. The value of capacitor 102 is small enough so as to not impact the output rectified voltage at node 50. Specifically, the value should not preclude the output voltage presented at node 50 from dropping down to 30% to 15% or less of its peak voltage of the rectifier output at the end of each half cycle. In other words, the voltage at the bottom of the “valley” should be no more than 10-18 volts at 120 volts, and preferably lower. Thus, the bypass capacitor should not “smooth” out the rectified AC voltage.

One embodiment of the values of the components shown in FIG. 1a are as follows:

| | |
|---|---|
| Driver 132 | IR Corp IR2153 or IR2153D |
| Transistors 144, 148 | N FET 250 v, 0.47 Ohm |
| Capacitor 102 | .22 μF 250 v, polypropylene |
| Diodes 104a-b, 124 | 1 A, 400 v general purpose diode, 1N4004 |
| Diode 130 | 1 A, 400 v fast diode, 1NF4004 |
| Transistor 116 | 2N2222 |
| Capacitor 134 | 1 μF 25 v, electrolytic |
| Capacitor 129 | 22 μF 25 v, electrolytic |
| Resistor 108 | 220 Ohm |
| Resistor 106 | 1 M Ohm |
| Resistor 118, 112 | 1k Ohm |
| Diode 114 | 14 v, 10%, 200 mW, Zener |
| Resistor 126 | 50k potentiometer |
| Capacitor 124 | 220 pF, mica |

Those skilled in the art will realize that other values or type of components may be used, and that certain values may be modified for different sized loads or power supply voltages.

### Resonant Circuit Section (Tank Circuit)

The output of the main portion 101 of the ballast (provided from the switching section) is identified as nodes 151 and 153. These nodes also serve as the inputs to the tank circuit 150, shown in FIG. 1b, and hence may be referred to as “input nodes” or “output node” based on the context. In particular, a first input node 151 is connected to the source and drain of NMOS transistors 144 and the other input node 153 is connected to transistor 148. The tank circuit 150 comprises a resonant circuit portion 14 that has a resonant frequency that is equal to or slightly lower than the switching frequency of the transistors. Typically, the lowest frequency operable for practical purposes is 18 kHz, and the upper frequency is limited by other practical considerations, but maybe as high as 80-100 kHz. While higher ranges are possible, such high switching frequencies generate greater amounts of noise and have higher switching losses. The resonant circuit is also connected to the tank circuit rectifier 16. In this embodiment, the tank circuit rectifier section 16 is shown as a four diode rectifier typically comprising fast recovery diodes. The tank circuit rectifier section 16 is then connected to the LED light source section 18, which comprises a single LED in this embodiment.

The resonant circuit can be viewed as a coupling device matching the impedance of the light source with the power source. The resonant circuit comprises an inductor 172 in series with a capacitor 170. The resonant circuit functions as an LC circuit that has a resonant frequency allowing energy to be alternately stored in the inductor and the capacitor. The resonant circuit can be characterized in one embodiment as generating an alternating voltage (e.g., a time varying voltage having a positive and negative value at different times). In addition, the resonant circuit can be characterized as providing an alternating current (e.g., a time varying current having a positive and negative value at different times). In many embodiments, a second capacitor may be added so as to provide an alternating current with a sinusoidal characteristic in the tank circuit. Thus, the resonant circuit may be viewed as a voltage source or current source, depending on how the load (e.g., rectifiers and LEDs) is coupled to the resonant circuit. In some embodiments, the coupling may occur using a transformer, which transforms the current/voltage on the primary winding (from the resonant circuit) to the secondary winding (to the rectifiers) according to well known principles.

The inductor 172 is generally a gapped core inductor that is capable of handling a peak current without fully saturating. The inductor processes both the lower line frequency current (e.g., 120 Hz) as well as the higher, switching frequency current (e.g., 20-100 kHz) and avoids saturation at the lower frequency. This is in contrast to prior art ballasts, which filter a rectified AC output voltage, resulting in a largely constant DC voltage with little 120 Hz ripple. Hence, the prior art inductors in the tank circuit (at least for gas-discharge light sources) are not designed to conduct a line frequency current because the ripple was removed by the smoothing capacitor. In FIG. 1b, the inductor stores energy from both the low and high frequency currents. The inductor may be gapped so as to reduce the heat caused during operation and to eliminate saturation at peak current of the low frequency current (which can be 3-4 amps, in some embodiments), although this is not as much of a concern for the low wattage loads associated with LEDs. The size of the gap depends on the permeability and saturating characteristic of the core material. In one embodiment, the gap is typically in a range of 0.1″ to 0.3″, which is much larger than found in a typical prior art ballast. Further, to handle the large current, the wire used is typically “litz” wire (also known as Litzendraht wire), which is wire made from a number of fine, separately-insulated strands, specially braided or woven together for reduced skin effect. Hence, this wire provides lower resistance to high frequency currents resulting in lower RF losses. The inductor's rating is largely determined by the higher frequency operation and a 0.8 mH inductor can be used for a 30 watt ballast. The inductor value must be such that it allows the circuit function to operate within the desired frequency range (18-80 kHz) and preferably above 40 kHz in order to meet certain energy efficiency standards. Further, the value of the inductance varies with the frequency of operation desired according to equation (1) below. Thus, a variety of inductance values can be used. For example, if a higher power factor is desired, a larger inductor can be used (although the physical size would be larger), whereas if a lower power factor is acceptable, a lower inductance (and hence a smaller size inductor) can be used. Thus, the inductance could be in this example less than 1 mH. Further, as the resonant frequency of the tank circuit is increased, the inductance value of the inductor is lowered.

In one embodiment, the inductor can be a toroid shaped core about 1 to 1.5″ in diameter having about 90 turns of Litz wire providing for about one mH (milli Henry) or less of inductance. In one embodiment, the toroid is a Magnetics® Kool Mu® 007707A7 core. Such a toroid at 20 watts or less should be able to provide a high power factor (e.g., pf=0.9 or higher). As the power increases for the same size inductor, the power factor will decrease. While this power factor may be still higher than other ballast arrangements, it may drop below pf=0.9, and thus would not be considered a high power factor.

In other embodiments, the inductor can be a “double E” core with an air gap, or other configurations using a material with a distributed air gap. Other core configurations can be used as known by those skilled in the art. The load ratings of the ballast for LED lights sources are typically lower power compared to other types of light sources (e.g., gas discharge lamps), and hence the inductor can be relatively smaller in value and size.

Returning to FIG. 1b, the inductor 172 is connected to capacitor 170 to store a charge therein. The capacitor 170 functions in part as a DC blocking capacitor as well as determining the capacitance of the LC circuit. Its value, in some embodiments, is about 1/10 the value of bypass capacitor 102, as a rough rule of thumb. However, other ratios can be used, but may not optimize the power factor. In various embodiments, the capacitor 170 has a value from 0.01° F. to 0.1° F.

The presence of the inductor insures that when current flows into the resonant circuit when the upper switch closes, the current is in phase with the supply voltage, thereby contributing to the high power factor of the circuit. The inductor is also required for the resonant circuit to oscillate, thereby allowing energy to be transferred back and forth from the inductor to the capacitor. The resonant frequency of an LC circuit is described by equation 1 below:

$${f}_{R} = \frac{1}{2 π \sqrt{LC}} \qquad Equation [ 1 ]$$

where f_{R} is the resonant frequency of the circuit, L is the inductance value of the inductor and C is the capacitance value of the capacitor 170.

The values of the inductor and capacitor components in the resonant circuit vary on the output power of the lamp and the desired resonant frequency. In Table 1 below, approximate values of the inductor and capacitor are indicated for certain embodiments, that are based on 120 VAC operation:

TABLE 1

| Capacitor | Inductor | | Freq. |
|---|---|---|---|
| Value | Value | | (kHz) |
| 16 nF | 1 | mH | 40 |
| 8 nF | .9 | mH | 60 |
| 5 nF | .8 | | 80 |

As evident, as the frequency increases, the inductor value decreases, allowing a smaller inductor to be used. This has an advantage in that it potentially allows a smaller size of the structure housing an integrated ballast and light source (“LED Bulb”). This may be desirable if the LED Bulb is intended as a replacement for incandescent bulbs. However, there is a practical upper limit of the switching frequency, because as the switching frequency increases, the overall system efficiency begins to decrease due to switching losses and other effects, such as the skin effect of the wire in the inductor.

### Tank Circuit Rectifier Section

The tank rectifier section 16 comprises in this embodiment a configuration 180 comprising four diodes 158a-158d. These are typically fast recovery diodes, such as 1NF4004 diodes, and are rated according to the current flow of the LED. In this embodiment which incorporates a single LED, the current requirements may be up to 1 or more amps. Since the voltage drop across the single LED light source is typically 3 volts, the current can be found according to Equation 2:

Wattage_{LED}/(V_{LED})=(Current_{LED}). Eq. 2

Thus, a 6 watt LED with 3 volts across the LED would have 2 amps current flowing through it.

### LED Section

The LED light source section 18 comprises in this embodiment a single LED. In this embodiment, because the LED is in series with the resonant circuit, the current rating is typically between 20 ma-100 ma. However, as will be discussed below, in other embodiments of the tank circuit, other LEDs can be used that are capable of handling 1000 ma-2000 ma (1-2 amps) of current (or more) and which are available from various suppliers. Other high power LEDs, including those capable of handling up to 3-6 amps (or more), can be used as the light source. The LED is connected to the output of the diode rectifiers, and once the diode rectifiers exceed the threshold voltage required by the LED diode, current flows through the LED for generating light. Typically, in a single LED the forward voltage drop is about 3 volts.

### Ballast Operation

The operation of the ballast can be described as follows. Household power comprising an AC voltage waveform is provided to the input of the input power section 2 and presented to the full wave bridge rectifier section 4. The AC waveform is transformed into a rectified waveform across nodes 50, 55. This waveform, shown as voltage waveform 200 of FIG. 2a, represents a time varying DC voltage having a shape that is a half sine wave, but that is repeated every half cycle of the line frequency (120 Hz). Further, the voltage exhibits “valleys” which correspond to the zero crossing point of the AC line input. These valleys have a zero or near zero voltage. The absence of a “filtering” (a.k.a. “smoothing”) electrolytic capacitor placed across the outputs of the full wave bridge, means that the rectified AC voltage exhibits valleys, which are not otherwise “smoothed” out. Thus, the waveform displays the valleys characteristic of ripple found in an rectified AC line voltage.

The IC driver section and the transistor section cooperate to turn switch 144 (“upper switch”) and switch 145 (“lower switch”) alternately on and off. This occurs at a high frequency which is also referred to as the switching frequency. When the upper switch is closed, the voltage from node 50 (the time varying DC voltage) is provided to the tank circuit. When the lower switch is closed, the upper switch is open and no rectified line voltage is provided to the tank circuit. The resulting voltage waveform provided to the tank circuit is shown in FIG. 2b as a series of high frequency square waves that follow the rectified AC voltage waveform. The switching frequency is much higher than the line frequency and the scale of FIG. 2b is deliberately set to illustrate the square wave with a lower frequency so as to illustrate the waveform. Otherwise, if the voltage waveform were illustrated at scale in FIG. 2b, it would be indistinguishable.

Thus, the input to the resonant circuit section comprises the square waves shown in FIG. 2b. When the upper switch 144 is closed, the voltage at the node 50 is provided as input into the resonant circuit section 14 and is present at node 151. The resonant circuit is tuned based on selecting the LC values to be a frequency slightly lower than the switching frequency, so that the energy providing by the high frequency square wave continuously pumps energy into the resonant circuit. Ideally, the switches switch at a zero energy level to minimize stress on the components, and to increase efficiency.

When the upper switch 144 closes, the voltage present at node 50 (which varies in value over time, as it is the rectified AC voltage), is provided to the resonant circuit. However, parasitic inductance in the power line to the ballast may inhibit current flow into the resonant circuit immediately after the upper switch closes. Thus, energy from the bypass capacitor discharges (because the capacitor will be at a higher potential) and provides current to the resonant circuit and ensures the resonant circuit continues operation. Then, as the inductance in the power line allows current from the power line to flow through the upper switch into the resonant circuit, further energy from the power line is provided into the tank circuit for the remainder of the half switching cycle. The charge from the bypass capacitor is relatively small, and is discharged within the half switching cycle. However, the bypass capacitor is sufficient in capacitor to ensure that current is flowing into the resonant circuit immediately after the upper switch closes. The bypass capacitor ensures the resonant circuit maintains resonance, and this is particularly applicable when dimming occurs, because no voltage is present from the rectified line voltage until the firing angle is encountered.

In the second half of the switching cycle, upper switch 144 opens and shortly thereafter, lower switch 148 closes. This essentially connects node 151 to node 153, which allows the energy in the resonant circuit to circulate therein. Essentially, energy is transferred between the inductor and capacitor, and current flow in the resonant circuit reverses direction. During the time when the lower switch is closed and the upper switch is open, the bypass capacitor 102 is being charged by the line voltage present on node 50. Consequently, when the next switching cycle begins, the bypass capacitor is charged and is ready to discharge when the upper switch closes, thus repeating the cycle. Thus, the current in the resonant circuit is continuously altering direction with energy continuously being introduced to maintain the cycle.

The value of the bypass capacitor must be sized within a range to achieve a desirable power factor and yet maintain operation of the resonant circuit. If, instead, the bypass capacitor were of such a large value (such as those prior art ballasts using an electrolytic smoothing filter capacitor), the bypass capacitor when discharging would provide so much current that the current drawn from the power source would be reduced. If the bypass capacitor were replaced with a smoothing capacitor that largely eliminated the voltage ripple in the rectified voltage, then current would be flowing into the tank circuit when the line voltage was crossing zero. This would result in current being drawn from the power source when the voltage was zero voltage. A large capacitor across the output of the rectifier would adversely affect the power factor of the ballast. Thus, the bypass capacitor is typically not an electrolytic capacitor and it is preferable to use a small value for the bypass capacitor such that a desirable power factor (e.g., from pf=0.7 or higher) is maintained during operation of the ballast. On the other hand, if the capacitor is too small, insufficient current would be provided to the ballast circuit when the upper switch initially closes, such that the resonant circuit may have insufficient current flow and ceases to function. Similarly, if the bypass capacitor is removed during operation, then the resonant circuit ceases to function.

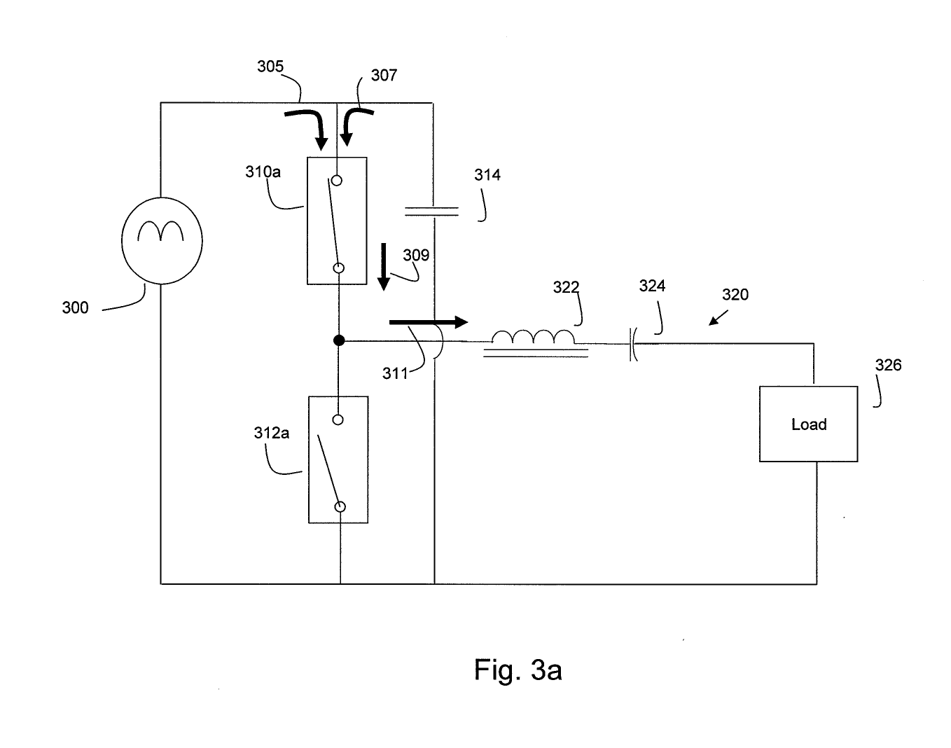

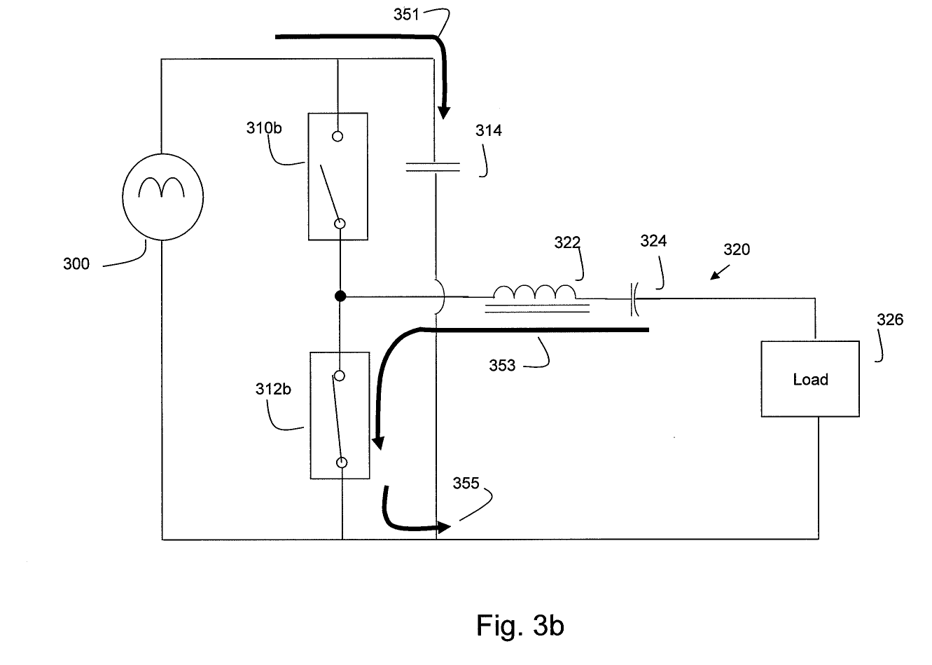

This operation may be explained with the aid of FIGS. 3a and 3b. In FIG. 3a, the ballast is represented in an abbreviated manner to focus on certain aspects. Namely, the rectified voltage source 300 is shown by a single symbol which represents the power source and rectifier sections—e.g., a rectified AC power source. Further, upper switch 310a and the lower switch 312a are shown as simple switches. These are assumed to be driven by an IC chip (not shown) receiving the appropriate power from a voltage regulator (not shown). The switches selectively provide an input to the tank circuit 320, shown here as comprising an inductor 322, a capacitor 324. The inductor and capacitor form the LC circuit, and the load 326 represents the light source and related components.

When the upper switch 310a closes, the lower switch 312a is open and the rectified voltage and current from the rectified voltage source 300 is allowed to pass through switch 310a into the resonant circuit. There typically is a slight delay in the current 305 from the power source 300 flowing into the ballast due to inductance in the wiring of the distribution system. Specifically, this includes inductance present in the distribution lines between the power source and the ballast. The wiring between the switch 310 and the commercial AC power source may include hundreds of feet of inside branch wiring in a building as well as wire outside the building, which has some small, but finite inductance. However, the inductance allows the current 305 to flow shortly after switch 310a closes. At the same time as switch 310a closes, bypass capacitor 314, which was previously charged, discharges 307 into the switch 310a, causing current 309, 311 to flow through the switch into the tank circuit. Thus, even if inductance in the power lines causes a momentary delay of the full current flow 305 from the power source, current 309 is flowing into the resonant circuit from the bypass capacitor to ensure that the resonant circuit maintains operation. The current provided by the bypass capacitor is relatively small in value, and quickly discharges, thereby providing high frequency energy to the circuit, so that it does not impact the flow of current 305 from the power source. The energy due to the current 309, 311 is stored in the resonant circuit 320 with some current flowing through the load, generating light. Note that this process occurs in the first half of the switching cycle. Thus, the charging/discharging of the bypass capacitor occurs many times during a cycle of the line voltage (e.g., 1/120 of a second) during which time the rectified input voltage is increasing and then decreasing. Thus, the current levels provided to the resonant circuit when the switch 310a closes vary, based on the level of the rectified AC voltage being switched. Because these current levels follow a sine wave in phase with the line voltage, a high power factor is achieved.

In FIG. 3b, the second half of the switching cycle is illustrated where switch 310b is open, and switch 312b closes. When the upper switch opens, the bypass capacitor 314 is being charged by current 351 from the power line. Because the upper switch is now open, no energy from the power line is introduced into the tank circuit. Then, because the lower switch is closed, current 353, 355 in the resonant circuit (which naturally reverses direction to the nature of LC circuits) reverses direction and flows from the tank circuit 320 through switch 312b and back into the tank circuit. Thus, current in the resonant circuit recirculates (as LC circuits naturally operate) and flows through the load, generating light.

In the embodiment of FIG. 3a, current 305 is based on a line frequency (60 Hz). As such, the small value of the bypass capacitor causes the reactance of the bypass capacitor at the power line frequency to be very high. On the other hand, current 307 from the bypass capacitor is a high frequency current and the bypass capacitor has a low reactance at the switching frequency (e.g., which can be 40-60 kHz in one embodiment). Thus, the bypass capacitor is suitable for discharging and providing current at the high (switching) frequency and filtering out high frequency noise that would otherwise be introduced back into the power source 300. Consequently, currents 309, 311 represent a combination of low frequency current (from the power source) and high frequency current (from the bypass capacitor 314). Similarly, in FIG. 3b, the current 351 into the bypass capacitor is a high frequency current.

Recall that the switches operate continuously. Returning to FIG. 2c, it is evident that the switches open and close many times both on the rising portion of the time varying DC voltage and the falling portion of the DC voltage. On the rising side, when the bypass capacitor discharges, it only discharges to the level of the DC voltage at that moment. Thus, although the bypass capacitor discharges down to the line level, this is still a level above zero volts. In other words, because the bypass capacitor discharges to the rectified AC voltage level, the bypass capacitor is only fully discharged (or essentially fully discharged) every 1/120 of a second (once every half line frequency) when the valley occurs on the rectified voltage. On the falling side of the DC voltage, the bypass capacitor is also discharged only to the line voltage as well. Although this is decreasing every switching cycle, it does not reach zero until the DC voltage reaches zero (in the “valley”). Because the current provided by the line source to the tank circuit when the upper switch closes is commensurate with the rectified voltage level, the current draw from the power source is in phase with the line voltage, and results in a high power factor. Had the DC voltage been “smoothed” to form a relatively constant DC voltage, the current provided when the upper switch closes would be the same every switching cycle. This would result in a current spike to charge the smoothing capacitor at the peak of the voltage sine wave thereby providing a poor power factor.

### Operation of Voltage Regulator

Returning to FIG. 1a and the operation of the voltage regulator 6, recall that the voltage regulator provides a sufficient operating supply voltage to the IC driver chip. The voltage regular accomplishes this by resistor 106 causing the NMOS transistor 110 to have a gate-source voltage and, in response, the transistor turns ON to conduct current. In the illustrated example, the resistor 108 generally configures the transistor 110 to operate in the safe operating area and in the event of excessive current flow. If so, it experiences a failure thereby uncoupling the transistor 110 from the node 50. Initially, the zener diode 114 conducts current into the base of transistor 116 causing the NMOS transistor 110 to block current from flowing into the second node 55 by presenting a large impedance of transistor 110, which causes the current to flow towards the gate drive supply voltage (Vcc) of the driver circuit 132. When current flows toward the gate drive supply voltage, the capacitor 129 stores the current energy as a voltage to provide a substantially constant voltage to the driver circuit 132. As a result, the driver circuit 132 turns ON and produces pulses via its respective outputs at a frequency determined by the resistance value of the adjustable resistor 126 and the capacitance value of the capacitor 124. In some embodiments, the adjustable resistor may be connected to another resistance in series (in one embodiment around 33 k), to avoid a condition where the adjustable resistor is set to zero (or a very low) resistance, thereby potentially damaging the driver integrated circuit. In other embodiments, the adjustable resistor can be set during manufacturing in order to adapt imprecise component values in the resonant circuit, so as to set the switching frequency of the transistors as desired relative to the resonant frequency. Recall that the switching frequency is slightly higher than the tank's resonant frequency. In other embodiments, the adjustable resistor 126 can be a fixed value resistor or equivalent depending on the desired operating frequency.

However, when the voltage across the zener diode 114 exceeds a corresponding breakdown voltage (e.g., about −14.0 volts, etc.), the zener diode 114 enters what is commonly referred to as “avalanche breakdown mode” and allows current to flow from its cathode to its anode. In response, the current flows across the resistor 120 and causes the transistor 116 to have a base-emitter voltage (V_{BE}), thereby turning ON transistor 116. The transistor 116 sinks current into the second node 55, which reduces the gate-source voltage of the NMOS transistor 110 and the current through the zener diode 114. Once the current in the zener diode 114 does not exceed the design of the output of the regulator value, the zener diode 114 recovers to the design value and reduces the current from flowing into the resistor 120. That is, by reducing the voltage at the source of the NMOS transistor 110, the voltage supplied to the driver circuit 132 does not substantially exceed the predetermined threshold voltage (Vₘₐₓ). In the example of FIG. 1a, the resistance value of the resistor 118 is selected to reduce the loop gain of the transistor 116 to prevent oscillations and the resistance value of the resistor 120 is selected to prevent a leakage current from flowing via the zener diode 114 into the base of transistor 116.

Thus, the illustrated voltage regulator 6 is configured to provide a substantially constant (i.e., regulated) voltage to the driver 8. When the rectified voltage provided via the rectifier 4 falls below a predetermined threshold voltage (V_{T}), the voltage output by the voltage regulator 6 decreases. However, the energy storage device 129 has a corresponding voltage that exceeds a minimum threshold voltage (V_{T}) and continues to provide energy to the driver circuit 132. In addition, when the voltage at the node 50 falls below the voltage of the regulator 120, the diode 124 prevents current from flowing backwards from the capacitor 129 into the NMOS transistor 110 and resistor 108 from the constantly discharged tank circuit via 50.

Turning now to the resonant circuit, the current flowing into the resonant circuit at the line frequency is largely maintained as a sine wave, and is largely in phase with the voltage at the line frequency from the power source. Further, the resonant circuit does not store any significant energy (inductive or capacitive) to distort the low frequency current during the time period between the half cycles, thereby causing the resonant circuit to appear as a resistive load to the power supply. Thus, the present circuit maintains a high power factor during operation provided the inductor is sized appropriate. In other embodiments, the inductor may be sized smaller (so as to consume less physical space) but doing so reduces the power factor. Thus, it is preferable to size the inductor so as to obtain a power factor greater or equal to 0.7. In particular, because the current flowing through the resonant circuit is substantially similar to a sine wave, the crest factor of the illustrated example is approximately the square root of 2 (e.g., about 1.5), which is close to an ideal crest factor. Contrast this to the prior art ballasts which require a dedicated power factor correction circuit to obtain a suitable crest factor.

### Other Tank Circuit Embodiments

In the embodiment of FIG. 1a, a single power consumed by the LED is limited by the current the tank circuit. A single high power LED light source may be several watts, and higher wattage LEDs are likely to be developed in the future. These type of LEDs would be difficult to drive with current present in the tank circuit shown in FIG. 1a. Further, higher currents in the resonant circuit impact the size of the components and generate heat in the ballast.

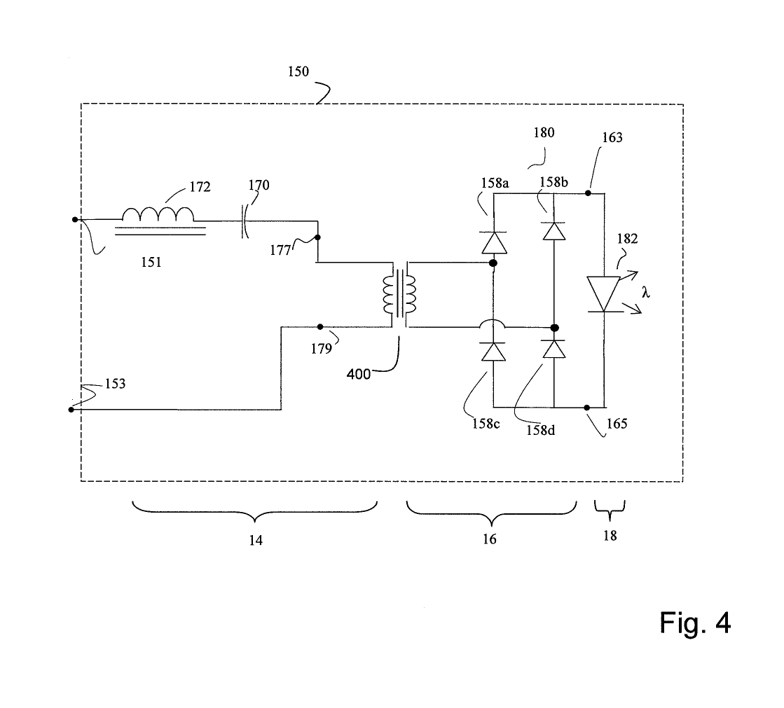

One alternative embodiment that can provide a higher current for a higher power LED while maintaining a lower current level in the resonant circuit is shown in FIG. 4. In FIG. 4, a transformer 400 has been added in the tank circuit to improve the matching characteristics between the LED and the resonant circuit. The transformer steps down the relatively higher alternating operating voltage in the tank circuit in its primary winding to a lower alternating operating voltage to the diodes 158a-158c connected to its secondary winding. Because a single LED light source is used, only a 3 volt drop is required across the LED when stepping down the voltage in the tank circuit. Use of the transformer allows the higher voltage in the resonant portion 14 of the tank circuit to be maintained at a relatively low current, while simultaneously decreasing the voltage on the secondary winding of the transformer, but increasing the current in the secondary winding (to the rectifier diodes). Thus, in this embodiment, the relatively lower current exists in the resonant circuit, and this provides less strain on the switching transistors, inductors, and other components in the ballast. In one embodiment, the transformer is an electrically isolated, highly permeable transformer having a turns ratio of approximately 10:1 turns, depending on the resonant circuit voltage. The turns ratio should also account for the rectifier voltage drop as well. Further, this type of arrangement allowing less current to flow in the resonant circuit produces less heat and energy losses in the inductor 172, which is also desirable.

In the embodiment of FIG. 4, the voltage across the LED 182, specifically at nodes 163 and 165 must be greater than the threshold voltage drop of the LED in order for current to flow. Until the voltage across the secondary winding of the transformer exceeds this level (and the associated rectifier diode voltage drop), no current flows through the LED and hence no light is produced. Although the voltage drop of the LED may only be 3 volts, the voltage across the secondary winding may be only slightly more, e.g., 4-6 volts in order to take into account the voltage drop of the rectifiers. Thus, from a percentage perspective, the voltage drop of the LED (3 volts) relative to the total voltage of the secondary (4-6 volts) can be a large ratio (up to 50%). This means a significant percentage of the energy is being lost due to the voltage drop of the rectifier diodes, as opposed to being used by the LED to generate light. The loss due to rectification can be lessened (and hence the efficiency can be further improved) by using rectifier diodes with a smaller voltage drop such as Schottky diodes, or other arrangements using synchronous rectification or center tapped transformers, (discussed below), which can increase the efficiency.

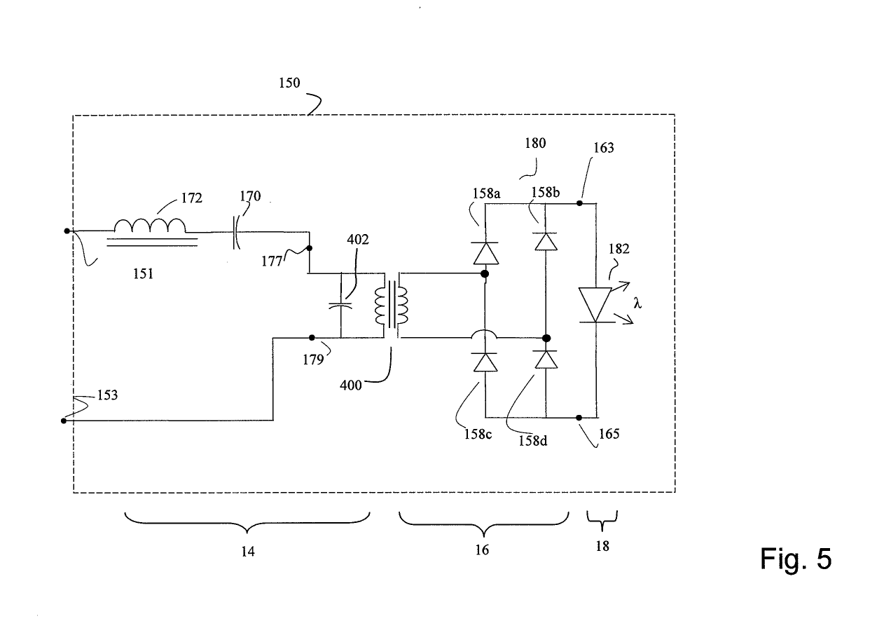

The resonant circuit can be modified as shown in FIG. 5 by adding a capacitor 402, sometimes referred to as a “starting” capacitor in order to allow the voltage across the LED to exceed the threshold faster. Typically, capacitor 402 is smaller or larger in value compared to capacitor 170 depending in part on the turns ratio of the transformer, and functions to create a voltage divider between capacitor 170 and 402. Thus, the voltage across nodes 177 and 179 will increase to a threshold voltage on the primary winding faster than without capacitor 402. Correspondingly, the voltage on the secondary winding will increase faster to reach the required voltage drop of the rectifiers 158 and LED light source 182.

In the embodiment shown in FIG. 4, the load is in series with the LC components and is a “series loaded” resonant or a “series loaded resonant converter” configuration. In this case, both capacitor values (170 and 402) largely determine the resonance of the circuit. In the series loaded configuration, the capacitance of capacitor 402 is relatively small relative to the load of the transformer, and the resonant circuit looks like a current source to the load. In the embodiment of FIG. 5, a capacitor was added across nodes 177 and 179. In this configuration, the transformer was connected in a “parallel loaded” or “parallel loaded resonant converter” configuration. In a parallel loaded configuration, the resonance of the circuit is largely determined by the capacitance of capacitor 402 and capacitor 170 functions as a DC blocking capacitor. In a parallel loaded configuration, the capacitance is relatively large relative to the transformer loading and the resonance circuit looks like a voltage source to the load. Thus, a variety of values are possible for capacitor 402.

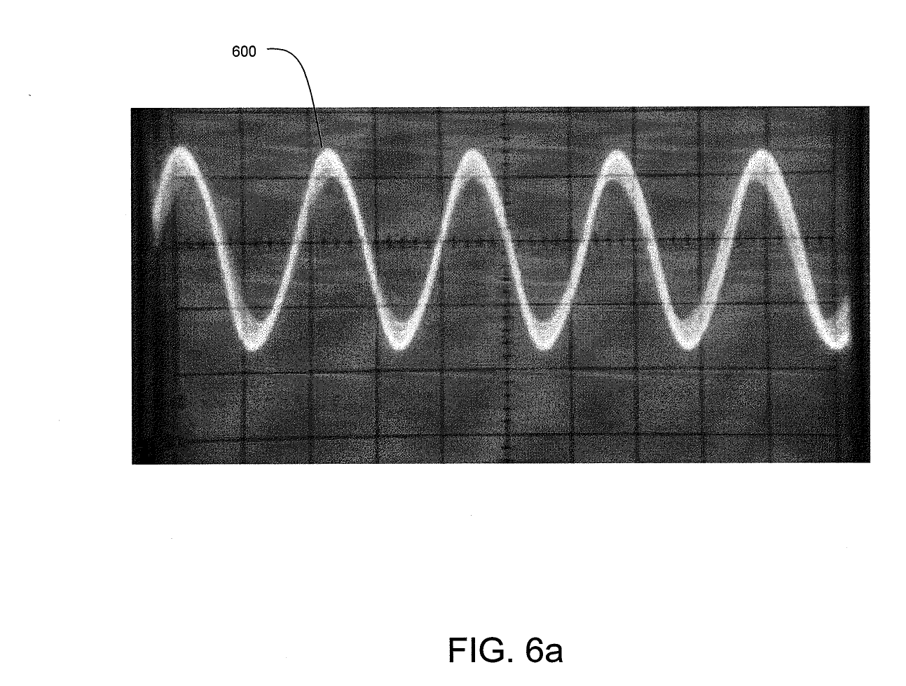

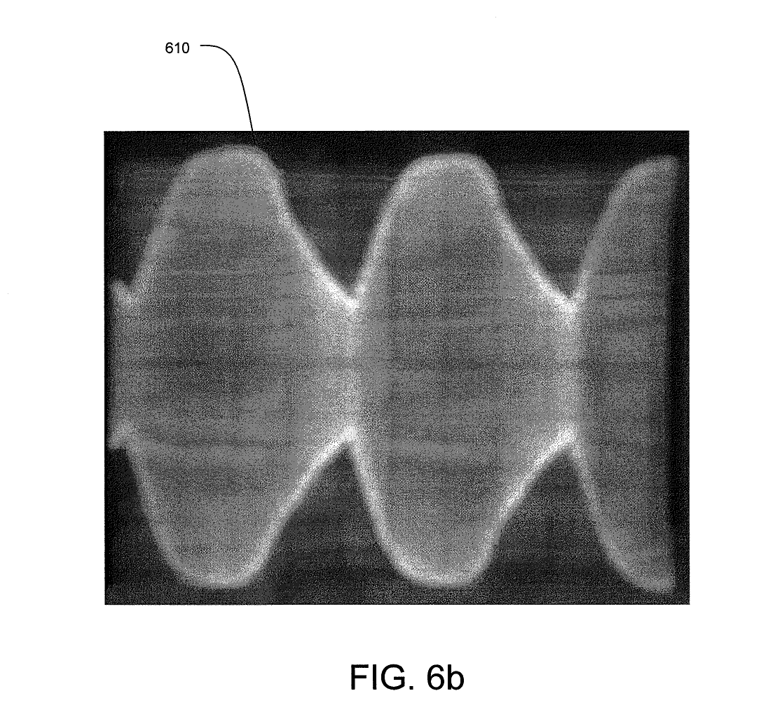

The voltage present across the primary winding of transformer 400 of FIG. 4 measured in one embodiment is shown in FIG. 6a. The voltage in a LC circuit is sinusoidal, and the resulting voltage 600 waveform at about 40 kHz is generally sinusoidal in shape. The voltage across the secondary winding is shown in FIG. 6b. This voltage 610 is shown at 120 Hz, and thus the switching voltage waveforms are generally not visible.

In this embodiment, for a 6 watt LED load, the bypass capacitor 102 may be 0.1° F., the resonant capacitor 170 may be 12 nF, the capacitor 402 may be 8.2 nF, the inductor may be 1 mH. These values are approximate. Further, because of variance in the tolerances of these parts, the switching frequency can be adjusted via the aforementioned potentiometer to tune the switching frequency to just above the actual resonant frequency. Adjustment of the potentiometer to adjust the switching frequency may be useful during manufacturing to compensate for component variances.

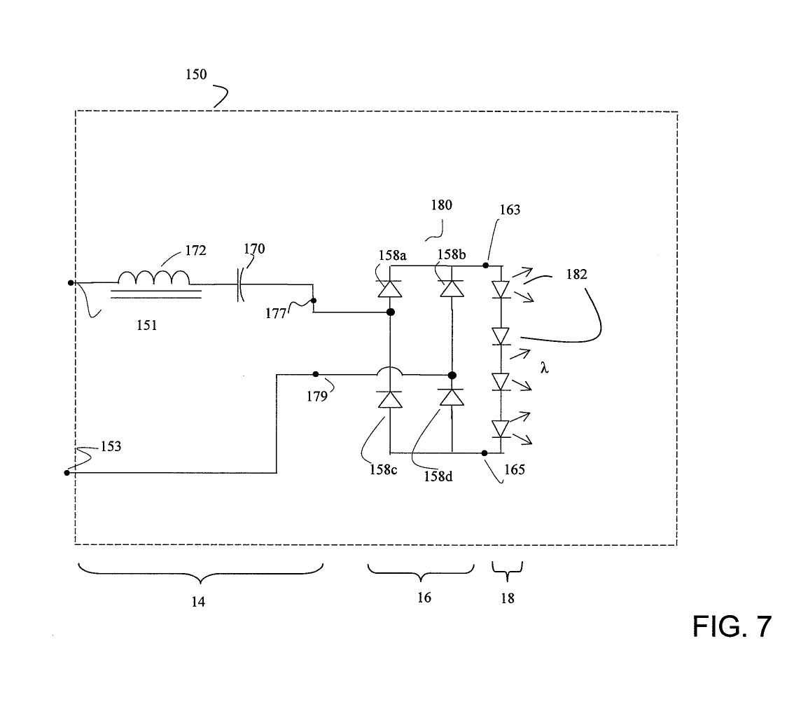

The wattage of a single LED has been traditionally limited by the materials used, and while new materials may allow greater power and light levels in a single LED, it is still desirable for many applications to have a light source producing more light than a single LED can produce. One solution is to use several lower power LEDs in series or parallel to generate more light. Further, these lower power LEDs are typically individually lower in cost. In one embodiment, a number of conventional LEDs are connected in series. These LEDs are typically conventional white-light emitting diodes, each having a 3 volt voltage drop. One such embodiment in shown in FIG. 7 where the light section 18 comprises four LEDs 182. Although only four LEDs are shown, in other embodiments there can be many more, such as over a hundred or more LEDs connected in series. These in turn can be combined in parallel to produce larger arrays. For parallel LED configurations, a balancing impedance configuration may be used. Such units of multiple LEDs can be readily purchased or assembled. Further, it is possible to have parallel arrays of LEDs in series. If one hundred LEDs are connected in series with each LED having approximately a 3 volt drop, then the total voltage drop would be around 300 volts with the current around 20 mA, resulting in a total output of around 6 watts. Adding a parallel array of LEDs would increase the current up to 40 mA.

In the embodiment shown in FIG. 7, four LEDs 182 are shown. Although in other embodiments a greater number of LEDs can be used, this is sufficient to illustrate how multiple LEDs in series can be accommodated. If each LED has a 3 volt drop, then the voltage across nodes 163 and 165 (across 4 LEDs) would be 12 volts. Thus, there must an operating voltage greater than 12 volts before any current would flow through the LED section 18 (not including the rectifier voltage drop). Similarly, if an array of one hundred LEDs are present, a voltage drop of 300 volts at nodes 163 and 165 is required in order for current to flow through the LEDs. At the higher voltage, it is more difficult to obtain resonance of the tank circuit, because current does not flow through the LEDs until the required voltage drop is reached across the LEDs. However, because of the larger voltage required, it is not until the voltage at nodes 177 and 179 rises above the voltage drop of the LEDs combined with the voltage drop of the diodes 158a-158d that any light will be generated. Thus, in an alternative embodiment, the capacitor 170 could be increased (e.g., to 0.1 μF), and the inductor driven so that its reactance provides the determined current to the rectifier diodes. In this case, the resonant section 14 is not operating near its resonant frequency, therefore acts as an inductive-reactive circuit. Therefore, the higher the operating frequency, the lower the current to the ballast. Adjusting the switching frequency would adjust the current from the inductor provided to the LEDs. In this embodiment, the current through the series LEDs is only 20 milliamps.

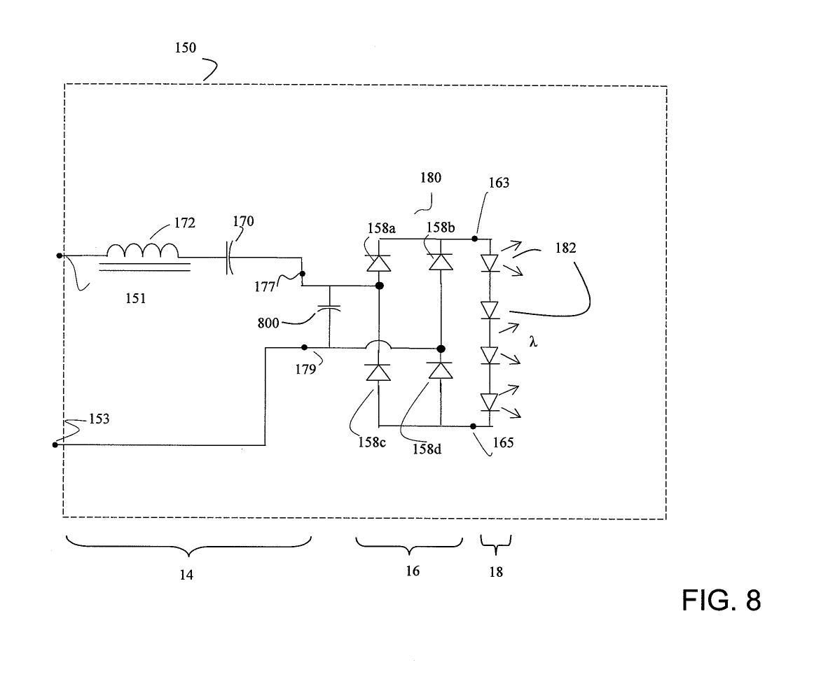

To facilitate the voltage presented to the diodes 158 (which is the voltage at node 177, 179) and reaching the required voltage threshold, the tank circuit can be modified as shown in FIG. 8. In FIG. 8, a starting capacitor 800 is added to the resonant circuit which acts as a voltage divider in conjunction with capacitor 170, which increases the voltage input to the rectifier portion 16 at nodes 177, 179. The starting capacitor allows current to flow in the inductor sooner in the cycle than would occur otherwise. In this configuration, by connecting the starting capacitor across the inputs of the rectifier portion the capacitor 800 is in a parallel loaded configuration with the rectifier portion 16. Thus, the LEDs 182 generate light sooner than would otherwise occur because the voltage across capacitor 800 rapidly increases. The addition of the capacitor does alter the resonant frequency of the tank circuit. Because the value of capacitor 800 is typically larger than capacitor 170, capacitor 800 largely determines the resonance of the circuit, and is effectively the resonance capacitor. Capacitor 170 then functions as a DC blocking capacitor, and ensures a symmetrical voltage is provided to the remainder of the tank circuit.

In other embodiments, a series loaded configuration is also possible. In a series loaded configuration, the rectifier in the tank circuit generally relies, in some manner, on a sinusoidal current waveform in the resonant circuit in order to generate light in the LED. In such instances the voltage may be a square wave across certain elements. In a parallel loaded configuration, the rectifier in the tank circuit generally relies, in some manner, on a sinusoidal voltage in the resonant circuit in order to generate light in the LED. Typically in a parallel loaded configuration, the sinusoidal voltage is obtained across a first capacitor in the resonant circuit, which is configured as a voltage divider with a second capacitor in the resonant circuit. In some embodiments, the magnitude of the first capacitor across the primary of the transformer can exhibit aspects of both series and parallel loading configurations. As seen herein, transformers may be used in the tank circuit to modify the alternating current or alternating voltage characteristics in order to facilitate operation of the ballast.

Thus, until the voltage across capacitor 800 causes a current through the LED, there is no load offered by the LEDs 182 in the tank circuit. In other words, the load presented by the LEDs 182 is present only when the voltage across the capacitor 800 exceeds the required voltage drop. In summary, capacitor 800 ensures the voltage into the full wave bridge rapidly builds up rapidly allowing current to flow through the LEDs.

If there are few conventional LEDs connected in series, then capacitor 800 is less likely to be present. However, if there are a large number of LEDs connected in series, then capacitor 800 facilitates sufficient voltage to ensure there is current flowing through the LEDs and serves as the main capacitance of the tank circuit. Thus, various embodiments possible. The selection of how many LEDs can be driven is dependent on various factors, and the tank circuit can be modified to accommodate these options.

The benefit of combining the tank circuit section 150 with the main ballast section 101 is that it results in a high efficiency, high power factor, dimmable LED ballast that can be readily adapted for different LED configurations. In order to accomplish this, the inductor should be sized so as to maintain operation in the non-saturated mode.

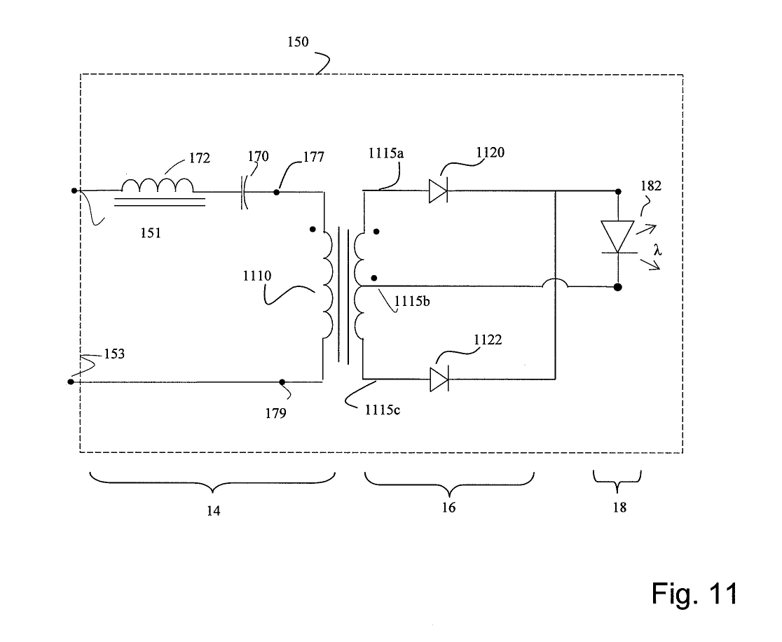

Another tank circuit embodiment is shown in FIG. 11. Although this tank circuit is shown as using a single LED, it can be adapted for multiple LED embodiments (whether these are configured in series or parallel). Turning to FIG. 11, the tank circuit 150 in this embodiment comprises a resonant circuit section 14, which has input nodes 151 and 153 receiving the output of the switching section. The resonant circuit comprises an inductor 172 and capacitor 170 in series with the primary winding of a transformer 1110. The transformer receives the voltage at node 177 and 179 across the input terminals of the primary winding, and provides a lower stepped down voltage on the output terminals of the secondary winding (but with a higher current), in proportion to the ratio of the turns winding. In one embodiment, the turns ration is 10:1.

The transformer 1110 in this case has a center tapped secondary winding. Thus, the secondary has three outputs 1115a, 1115b, and 1115c. The center tap 1115b is connected to the cathode of the LED 182, and each of the outer secondary winding connections 1115a, 1115b are connected to the anode of the LED via a respective diode 1120, 1122. During operation, namely during a first part of the switching cycle, the LED 182 is receiving current from the upper secondary winding, namely connection 1115a, with current passing through diode 1120 through the LED 182, and back to the center tap 1115b. During the other half of the switching cycle, current is flowing from other connection 1115c through the diode 1122, to the anode of the LED 182, and back to the center tap secondary winding, connection 1115b. In this embodiment, during each cycle, there is only one diode for which there is a rectifier diode voltage drop. Other variations on FIG. 11 are possible. For example, the embodiment of FIG. 11 can be modified by reversing the diodes 1120, 1122, and LED 182.

This embodiment only involves two rectifying diodes 1120 and 1122, so that a lower diode voltage drop represents greater efficiency of operation compared to using four diodes. Thus, this improves the rectification efficiency by 100% relative to using a full bridge rectifier configuration. For a ballast using only a single LED, the reduced voltage drop in the rectifying section 16 represents a significant increase in efficiency, relative to using four diodes. Although this embodiment can also be used with multiple LEDs, the relative efficiency gains are not as great as the number of LEDs increases.

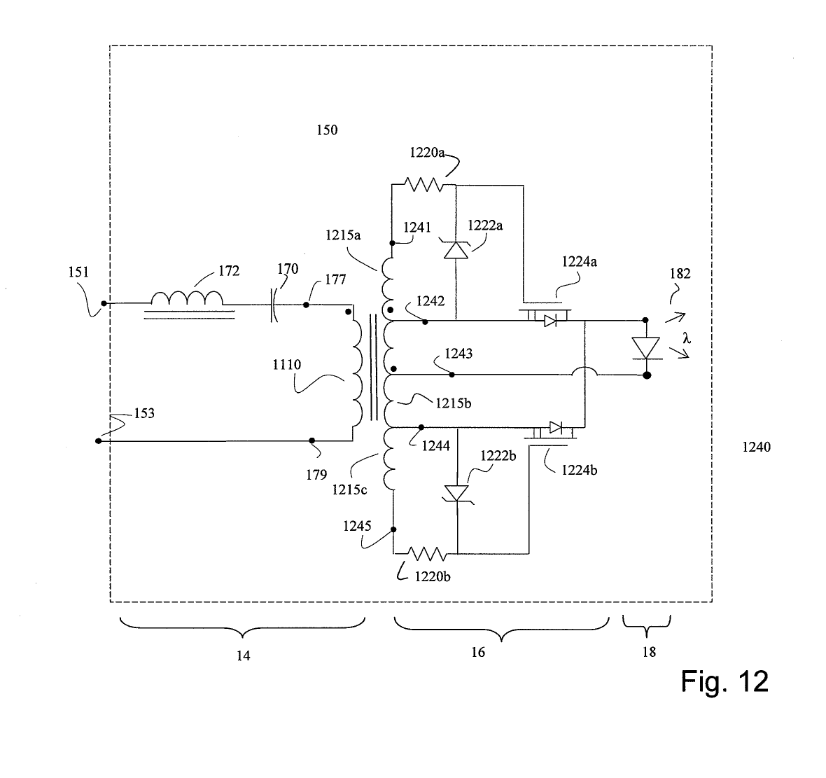

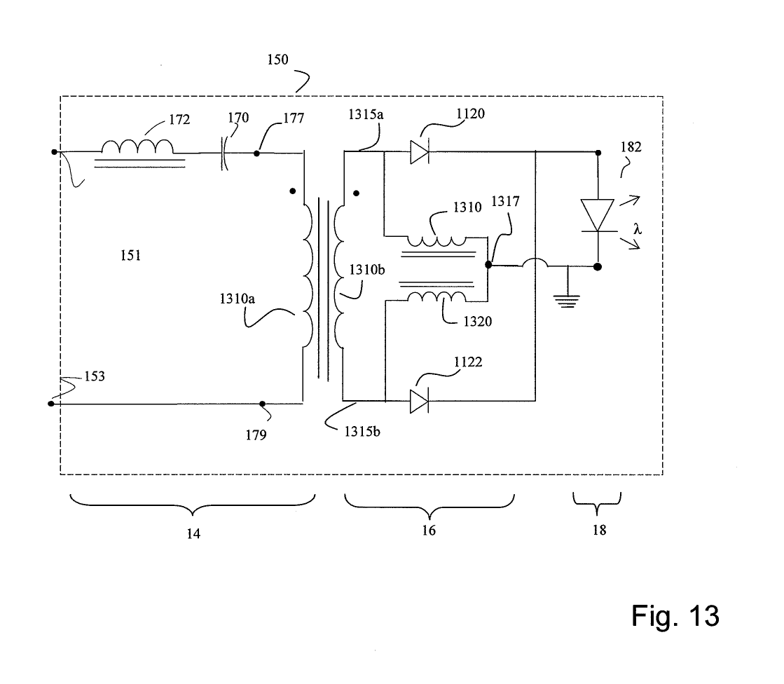

The embodiment of FIG. 11 can be modified to provide an even lower voltage drop in the rectifying section. In one variation, Schottky diodes can be used which offer a lower voltage drop. Other embodiments may use other types of diodes. One such embodiment is shown in FIG. 12. In FIG. 12, a transformer remains configured in series with the resonant circuit, but the secondary winding comprises a main secondary winding 1215b and two “tertiary” or “gate control” windings 1215a, 1215c that control the gates of switching elements. Thus, the secondary winding in this embodiment can be viewed as having five output terminals—an output terminal 1241 and 1245 from the outer gate control windings, two output terminals 1242, 1244 from the main secondary winding, and a center tap output terminal 1243. In this embodiment, the rectifying diodes 1120, 1122 in FIG. 11 are replaced with MOSFET switching elements 1224a and 1224b, respectively. The MOSFETS incorporate a built-in diode which has a lower voltage drop. Using MOSFET 1224a to illustrate operation, the MOSFET is controlled at its gate by circuit comprising gate control winding 1215a, resistor 1220a, and zener diode 1222a. A corresponding circuit is shown for the other MOSFET, which includes gate control winding 1215c, 1220b, and zener diode 1222b.

During operation, the voltage from the main windings (e.g., terminals 1242 and 1244) provide a voltage that is rectified by MOSFET 1224a and 1224b respectively. The gate control windings provide a voltage greater than that generated by the main windings. The MOSFETS are turned ON when the voltage at terminal 1241 increases above a threshold amount above the voltage at node 1242 thereby allowing the gate to turn the MOSFET ON. The resistor 1220a and zener diode 1222a limit the current and voltage so that the MOSFET is only turned ON at the appropriate times in a synchronous manner. Similarly, the corresponding components for MOSFET 1224b turn ON at complimentary times. In this manner, the time varying DC voltage generated from the resonant alternating voltage in the resonant circuit is provided to the LED to produce light.

Another embodiment of the tank circuit is illustrated in FIG. 13. This embodiment incorporates what is known as a “current doubler rectifier.” This embodiment comprises a transformer having a primary winding 1310a and a secondary winding 1310b, but the secondary winding does not have a center tap. Each output terminal 1315a and 1315b is connected to an inductor 130 and 1320 respectively. The other ends of the inductors are connected together at node 1317, which in turn is connected to the LED 182. In other embodiments, multiple LEDs may be used.

During operation, the current from each inductor is added to provide the current through the LED, but the secondary winding only carries half of the output current (hence, the name “current doubler”). The rectifiers 1120, 1122 function as described previously, and in other embodiments, these diodes may be part of a MOFSET to provide further efficiency gains.

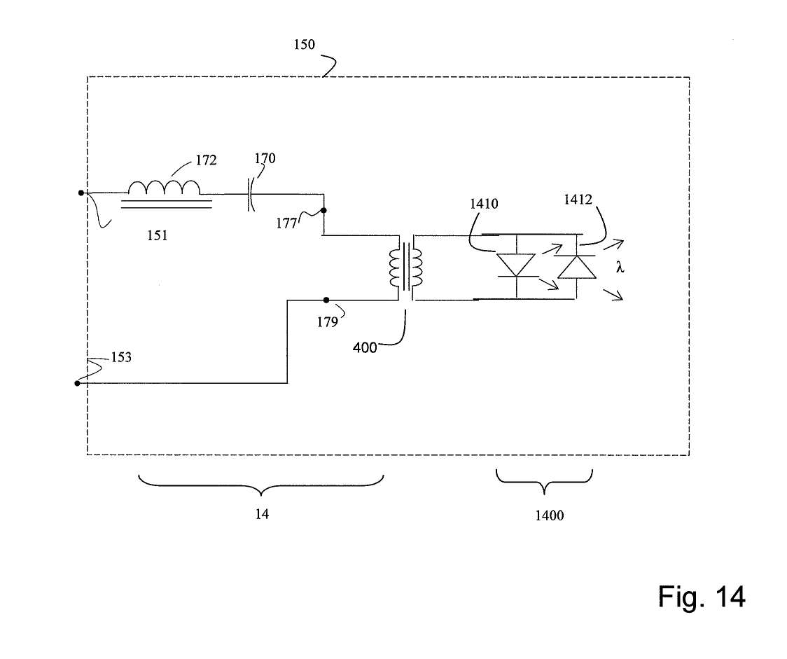

Still another embodiment is shown in FIG. 14. In FIG. 14, the tank circuit comprises the inductor 172 and capacitor 170 and transformer 400 as discussed before, but in this case there is no explicit rectifier section coupled with the LED section as in other prior embodiments. Rather, there is a so-called anti-parallel LED 1400 configuration. In this embodiment, the LEDs 1410 and 1412 are each configured in a parallel configuration, but with the anode of one LED connected to the cathode of the other LED, and vice versa. In this configuration, each LED conveys current during a half cycle. Thus, each LED generates light every other half cycle, but operates on different half-cycles. Other configurations using multiple LEDs are possible.

### Dimming

The various embodiments of the ballast can be effectively dimmed using a conventional triac based phase control dimmer, including the dimmer disclosed in U.S. patent application Ser. No. 12/205,564 filed on Sep. 5, 2008, which in turn claims the benefit under 35 U.S.C. § 119(e) to U.S. Provisional Patent Application entitled “Two-Wire Dimmer Switch for Dimmable Fluorescent Lights” filed on Feb. 8, 2008, bearing Ser. No. 61/006,967, both of which are herein incorporated by reference for all that each teaches (referred to as “Two Wire Dimmer”).

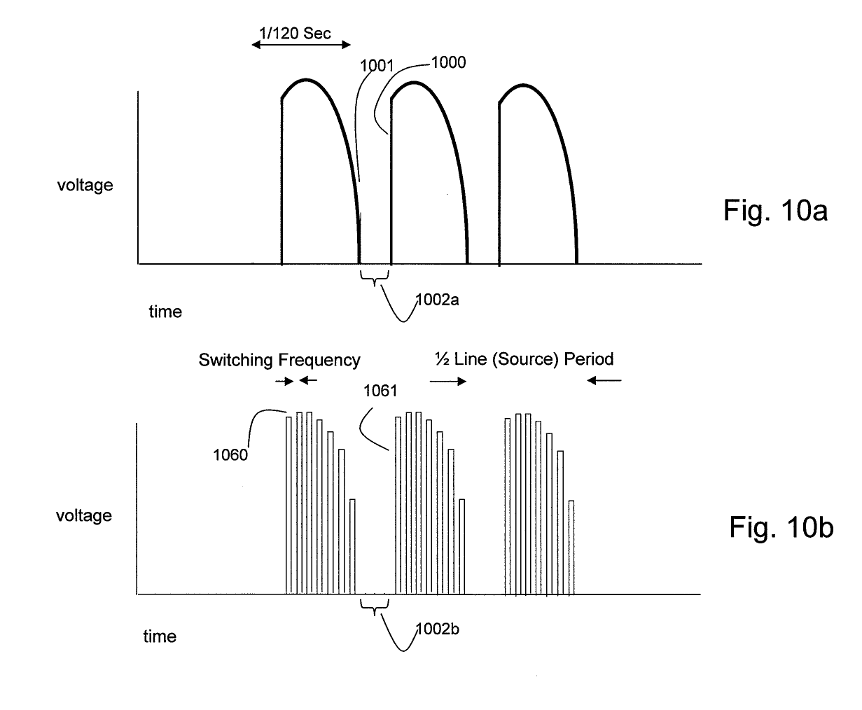

The effect of the Two Wire Dimmer on the incoming supply voltage to the ballast is shown in FIG. 10a. The Two Wire Dimmer incorporates a full wave bridge rectifier so that the output of the dimmer is a rectified voltage. Thus, the ballast does not receive an AC voltage, but a rectified AC voltage. When the Two Wire Dimmer is activated, e.g., it dims, the phase angle (a.k.a. “firing angle”) of the voltage is varied (known as a “phase angle control” dimmer), and one embodiment of the resulting voltage is shown in FIG. 10a.

In FIG. 10a, the leading portion of the rectified waveform 1000 occurs at a delay from its normal rise, and is effectively set to zero volts for the delay period (see, e.g., 1002a). If dimming is not activated, the “valley” as noted before would occur at point 1001. However, with dimming, the voltage does not immediately rise after the valley, but is zero for a variable amount of time. This results in the portion 1002a where the line voltage is zero volts as input to the ballast. Such a dimmer is sometime referred to as a “phase angle” control dimmer. The point at which the rectified line voltage is allowed to pass through the dimmer circuit is called the “firing angle.” As the user controls the dimmer to dim to a greater level, the firing angle increases, and results in a lower average voltage being provided by the dimmer to the ballast, thus dimming the light. With a lower average energy level is thus provided to the tank circuit, a lower average current is present in the tank circuit, which causes a lower average light to be provided by the LEDs. This is in distinction to the prior art for gas discharge ballast which rely on altering the switching frequency to alter the energy provided to the tank circuit in order to dim the light.

Although there is no voltage to the ballast provided during time period 1002a, there is sufficient voltage provided to the IC driver, allowing the switching of the switches to continue during this time period. Recall that there is a housekeeping capacitor in a voltage regulator that provides power to the IC, and the charging of the housekeeping electrolytic capacitor in the voltage regulator is performed at the very beginning of the voltage waveform produced from the output from the dimmer. The charging of the housekeeping capacitor dissipates the stored inductance in the house wiring that is created when the phase controlled dimmer is turned ON. This would normally cause a ringing of current of the input bypass capacitor if it were not damped by the load presented by the series regulator at this precise time during the charging of the housekeeping capacitor. The housekeeping capacitor also provides energy to the IC driver during the portion 1002a when there would otherwise be insufficient voltage to driver the IC.

Further, the ballast may also incorporate an optional resistor 103 in the power input section (see FIG. 1a) that functions to absorb energy. This small resistor lessens the impact of current ringing that can occur with prior art dimmers. The presence of the resistor, in addition to dampen any ringing, can aid in the ballast surviving a transient over-voltage condition and act as a fuse to protect other devices on the branch circuit. Thus, even though the destruction of the resistor would result in the ballast being non-functional, it would prevent the ballast from tripping a circuit breaker. Other well known circuit components may be incorporated to dampen the ringing and/or protect the circuit from over-voltage conditions. Because the impact of current ringing is more significant for low loads particularly used with conventional triac based dimmers, the use of the resistor in an LED ballast provides additional benefits relative to its use in gas-discharge lamps, which typically have a greater load compared to LED light sources.

The impact of dimming on the voltage output of the switching power is shown in FIG. 10b. Recall that the upper switch allows a square wave shaped waveform to be provided to the tank circuit, where the waveform tracks the rectified DC voltage in the ballast. Since the rectified DC voltage in the ballast is as shown in FIG. 10a (because that is the waveform of the input to the ballast), the resulting square wave when using a dimmer is shown in FIG. 10b. In this case, a corresponding portion of the square wave in the ballast is set to zero volts because the corresponding line voltage input to the ballast was set to zero volts. The impact of increasing the dimming level is to increase the duration of portion 1002b, whereas decreasing the dimming shortens the portion 1002b.

During the portion 1002b, there is no voltage provided to the ballast. The switching of the switches continues during this time period, so that when the upper switch closes, there is no energy provided to the ballast. While the bypass capacitor provides some charge to the resonant circuit when the upper switch closes, the bypass capacitor by itself does not have enough charge to maintain operation of the resonant circuit during period 1002b. The absence of any energy into the tank circuit causes the energy in the resonant circuit to quickly reduce. Once the voltage available to the diode rectifiers in the tank circuit drops below a certain voltage, no further current will be drawn from the resonant circuit and no light is generated. However, even though the energy in the tank circuit reduces to a level that is not able to generate light the LED, the resonant circuit is still resonating, albeit at a diminishing energy level with each switching cycle.

When the phase dimmer restores the rectified line voltage at 1061, energy is provided back into the tank circuit via the upper switch. Because the switches continuously operate in synchronization with the resonant circuit, the energy level can be quickly restored and light is quickly regenerated by the LED. Because the voltage at the rectified line voltage appears as a “step function” at point 1061, a high level of voltage is provided to the tank circuit to immediately energy it. However, the existence of the zero-voltage portion 1002b reduces the average current available to the LED light source during a half cycle of the line frequency, and thus, the average light generated must also be reduced.

Further, in the case of dimming, during period 1002b, there is no voltage, and hence no current drawn by the resonant circuit. This reduces the overall energy consumed by the ballast overall. The power factor during operation with a dimmer is slightly reduced relative to operation without it. However, for the portion of rectified line voltage that is non-zero, the current draw of the ballast is largely in phase with the line voltage. Consequently, even with dimming, the power factor is relatively high.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A lighting ballast comprising:
a full wave bridge rectifier configured to receive an AC line voltage having a line frequency, and provide a time varying DC voltage comprising a rectified AC line voltage at a first output node and a second output node of said full wave bridge rectifier;
a driver circuit configured to receive a supply voltage derived from said time varying DC voltage, said driver circuit configured to provide a periodic first output signal and a periodic second output signal wherein said first output signal and said second output signal operate at a switching frequency less than 100 kHz;
a first switching element having a first terminal connected to said first output node of said full wave bridge and a second terminal connected to an input of a tank circuit, said first switching element configured to receive said first output signal and in response connect said first terminal to said second terminal thereby providing said time varying DC voltage to said input of said tank circuit; and
a second switching element having a first terminal connected to said input of said tank circuit and a second terminal connected said second output node of said full wave bridge rectifier, said second switching element configured to receive said second output signal and in response connect said first terminal of said second switching element to said second terminal of said second switching element thereby connecting said input of said tank circuit to said second output node of said full wave bridge rectifier;
a non-electrolytic capacitor connected across said first output node and said second output node of said full wave bridge, wherein said non-electrolytic capacitor is configured to at least partially discharge when said first switching element provides said time varying DC voltage to said input of said tank circuit, said non-electrolytic capacitor configured to charge when said first switching element does not connect said time varying DC voltage to the input of said tank circuit,
wherein said lighting ballast does not have an electrolytic capacitor having a first terminal connected to said first output node and a second terminal connected to said second output node,
wherein said tank circuit is configured to operate at a resonant frequency less than or equal to said switching frequency and
said tank circuit comprises:
a) a resonant circuit comprising an inductor connected in series with a second capacitor, said resonant circuit configured to generate an alternating voltage,
b) a rectifier circuit coupled to said resonant circuit, said rectifier configured to generated a second-DC voltage, and
c) one LED or a plurality of LEDs connected in series configured to receive said second time varying DC voltage to generate light.

2. The system of claim 1 wherein said resonant circuit is configured to generate a sinusoidal alternating voltage provided to said rectifier circuit.

3. The system of claim 1 wherein said resonant circuit is configured to generate a sinusoidal alternating current provided to said rectifier circuit.

4. The system of claim 1 wherein the non-electrolytic capacitor is a value equal to or less than 2 micro farads and the ballast is configured to continuously consume no more than 20 watts of power.

5. The system of claim 1 wherein said lighting ballast is configured to provide a lower average current in the resonant circuit when said AC line voltage is processed by a phase control dimmer by increasing the firing angle.

6. The system of claim 1 wherein a power factor of the lighting ballast during operation is greater than 0.8.

7. The system of claim 1,
wherein said rectifier circuit in said tank circuit comprises a second full wave bridge rectifier having input terminals and output terminals, wherein said input terminals are configured to receive said a current passing through said resonant circuit and wherein said second DC voltage is provided at said output terminals of said second full wave bridge rectifier.

8. The system of claim 1 wherein said tank circuit further comprises:
a transformer comprising a primary winding and a secondary winding, said primary winding comprising input terminals configured to receive a current passing through said resonant circuit and provide a second current in said secondary winding, wherein said secondary winding comprises a first output terminal and a second output terminal connected to said input terminals of said second full wave bridge rectifier.

9. The system of claim 1 wherein said tank circuit further comprises:
a transformer comprising a primary winding and a secondary winding, said primary winding comprising input terminals configured to receive a portion of a current passing through said resonant circuit and provide a second current in said secondary winding, wherein said secondary winding comprises a first output terminal and a second output terminal connected to said input terminals of said second full wave bridge rectifier; and
a second capacitor having a first terminal and a second terminal connected across the input terminals of said primary winding of said transformer into which another portion said current passes.

10. The system of claim 1 wherein said tank circuit further comprises:
a transformer comprising a primary winding and a secondary winding, said primary winding comprising input terminals configured to receive at least a portion a current passing through said resonant circuit and provide a second current in said secondary winding, wherein said secondary winding comprises a first output terminal and a second output terminal connected to said input terminals of said second full wave bridge rectifier; and
a second capacitor having a first terminal and a second terminal connected across the output terminals of said secondary winding of said transformer.

11. The system of claim 9 further comprising a single LED connected in series between said output terminals of said second full wave bridge rectifier wherein the current passing through the single LED is greater than the current in the resonant circuit.

12. The system of claim 1 further wherein
said driver circuit comprises an integrated circuit providing said first output signal and said second output signal, said integrated circuit configured to continuously operate at a constant switching frequency.

13. The system of claim 12 further comprising a power supply circuit for supplying said supply voltage to said integrated circuit.

14. The system of claim 1 further comprising
a transformer having a first input terminal and a second input terminal configured to receive at least a part of a current flowing through said resonant-circuit, said transformer having a first output terminal connected to a first terminal of a first diode, a center tap output terminal, and a second output terminal connected to a first terminal of a second diode, wherein at least said one LED or one of said plurality of LEDs is connected in series between said center tap output terminal and a second terminal of said first diode.

15. The system of claim 14 further comprising a first inductor and a second inductor coupled to said secondary winding in a current doubler configuration.

16. The system of claim 14 wherein the first diode is part of a first MOSFET and the second diode is part of a second MOSFET.

17. A system for providing power to one LED or a plurality of LEDs comprising:
a full wave bridge rectifier providing a rectified AC line voltage;
a non-electrolytic capacitor having a first terminal and a second terminal, said capacitor having a reactance of more than 1 ohm at a switching frequency;
a first switching element having a first terminal and a second terminal, said first terminal connected to said first terminal of said non-electrolytic capacitor, said first switching element configured to switch said rectified AC line voltage present on said first terminal of said first switching element to said second terminal of said first switching element at the switching frequency;
a second switching element having a first terminal connected to said second terminal of said first switching element, said second switching element having a second terminal connected to said second terminal of said non-electrolytic capacitor, said second switching element configured to switch said first terminal of said second switching element to said second terminal of said second switching element at said switching frequency;
a resonant circuit comprising an inductor and a first capacitor configured in series, said resonant circuit configured to have an resonant frequency that is less than or equal to said switching frequency, wherein said inductor is configured so as to not saturate at a line frequency of the AC line voltage, wherein said resonant circuit comprises a first input node connected to said second terminal of said first switching element, said resonant circuit having a second input node connected to said second terminal of said non-electrolytic capacitor, wherein an sinusoid or square wave alternating operating voltage and an alternating current is generated in said resonant circuit, and
two or more diodes coupled to said resonant circuit to receive said sinusoidal or square wave voltage, said two or more diodes configured to provide a time varying DC voltage across said one LED or a plurality of LEDs,
wherein said lighting ballast does not have an electrolytic capacitor having a first terminal connected to said first output node and a second terminal connected to said second output node,
wherein said lighting ballast does not have an inductor connected to said full wave bridge, and
wherein the ballast is configured to continuously consume no more than 20 watts of power or less.

18. The system of claim 17 wherein said two or more diodes form a rectifier configured to receive at least part of said alternating resonant current and provide said time varying DC voltage to output terminals of said full wave bridge rectifier wherein said one LED or a plurality of LEDs is connected between said output terminals of said full wave bridge rectifier.

19. The system of claim 18 wherein the two or more diodes form a current doubler circuit.

20. The system of claim 17 further comprising:
a transformer with a primary winding comprising first and second input terminals configured to receive at least part of said alternating resonant current and produce a second alternating operating voltage at output terminals of a secondary winding, where said second alternating operating voltage has a lower voltage than said alternating operating voltage, wherein said two or more diodes form a rectifier having output terminals across which said time varying DC voltage is provided.

21. The system of claim 20 wherein said two or more diodes comprise a first diode in a first MOSET and a second diode in a second MOSFET.

22. The system of claim 20 further comprising
a third capacitor having a first terminal connected to said first input terminal of said primary winding and a second terminal connected to said second input terminal of said primary winding and wherein at least another part of said current flows through said third capacitor.

23. The system of claim 17 further comprising
a transformer with a first input terminal, a second input terminal, a first output terminal, a center tap output terminal, and a second output terminal, wherein
said first input terminal is connected in series with said first capacitor,
said second input terminal is connected to said second terminal of said second switching element,
said center tap output terminal is connected to a first terminal of said one LED or a plurality of LEDs,
said first output terminal is connected to a first terminal of a first diode, and
said second output terminal is connected to a second terminal of a second diode,
wherein a second terminal of said first diode and a second terminal of said second diode are connected to a second terminal of said one LED or another one of the plurality of LEDs.

24. The system of claim 17 further comprising
configured to be usable with a phase angle dimmer circuit that provides a modified rectified AC line voltage having a firing angle, wherein said light generated by said one or more LEDs varies with said firing angle.

25. A method for operating a ballast comprising:
receiving household line voltage at a line frequency at input terminals of a full wave bridge rectifier;
providing a rectified AC voltage comprising a time varying DC voltage having a peak voltage wherein said time varying DC voltage is not filtered from the line frequency, said time varying DC voltage present across a first output terminal and a second output terminal of said full wave bridge rectifier, said time varying DC voltage having a period of twice the line frequency, said time varying DC voltage present across said first output terminal and said second output terminal;
connecting said first output terminal to an input node of a resonant circuit for a first time period by a switching element operating at a switching frequency, said first time period defined by the switching frequency, thereby providing said time varying DC voltage to said resonant circuit during said first time period, said resonant circuit comprising an inductor and a capacitor connected in series, said resonant circuit having a resonant frequency less than or equal to said switching frequency, said inductor configured to not saturate when a time varying current passes through said inductor having a frequency twice the line frequency;
discharging at least in part a non-electrolytic capacitor into said resonant circuit during said first time period, wherein said non-electrolytic capacitor has a first terminal and a second terminal, wherein said first terminal is connected to said first output terminal of said full wave bridge rectifier and said second terminal is connected to said second output terminal of said full wave bridge rectifier, wherein further said non-electrolytic capacitor allows said time varying DC voltage to drop to a voltage value of no more than 30% of said peak voltage once during a period equal to twice the line frequency;
generating an sinusoidal alternating operating voltage in said resonant circuit as a result of switching said switching element;
producing a second time varying DC voltage based on rectifying said sinusoidal alternating operating voltage; and
providing said second time varying DC voltage to one or more LEDs thereby generating light.

26. The method of claim 25 wherein the inductor does not saturate during operation from a current comprising:
i) a first time varying current at the resonant frequency produced by the non-electrolytic capacitor having a switching frequency component that is added to
ii) a second time varying current produced by the full wave bridge rectifier having a 120 hertz component.

27. The method of claim 25 further comprising the step of:
generating a control signal for said first switching element using an integrated circuit, said control signal operating at said switching frequency, wherein said switching frequency is less than 100 kHz.

28. The method of claim 25 wherein the step of producing said second time varying DC voltage further comprises:
receiving said sinusoidal alternating operating voltage at the input of a rectifier, and producing said second time varying DC voltage at output terminals of said rectifier.

29. A lighting ballast comprising:
a full wave bridge rectifier configured to receive an AC line voltage having a line frequency, and provide a time varying DC voltage comprising a rectified AC line voltage at a first output node and a second output node of said full wave bridge rectifier;
a driver circuit comprising an integrated circuit configured to receive a continuous supply voltage derived from said time varying DC voltage, said driver circuit configured to continually provide a periodic first output signal and a periodic second output signal wherein said first output signal and said second output signal operate at a switching frequency less than 100 kHz;
a first switching element having a first terminal connected to said first output node of said full wave bridge and a second terminal connected to an input of a tank circuit, said first switching element configured to receive said first output signal and in response connect said first terminal to said second terminal thereby providing said time varying DC voltage to said input of said tank circuit; and
a second switching element having a first terminal connected to said input of said tank circuit and a second terminal connected said second output node of said full wave bridge rectifier, said second switching element configured to receive said second output signal and in response connect said first terminal of said second switching element to said second terminal of said second switching element thereby connecting said input of said tank circuit to said second output node of said full wave bridge rectifier;
a non-electrolytic capacitor connected across said first output node and said second output node of said full wave bridge, wherein said non-electrolytic capacitor is configured to at least partially discharge when said first switching element provides said time varying DC voltage to said input of said tank circuit, said non-electrolytic capacitor configured to charge when said first switching element does not connect said time varying DC voltage to the input of said tank circuit,
wherein said lighting ballast does not have an electrolytic capacitor having a first terminal connected to said first output node and a second terminal connected to said second output node,
wherein said tank circuit is configured to operate at a resonant frequency less than or equal to said switching frequency, and
said tank circuit comprises:
a) a resonant circuit comprising an inductor connected in series with a second capacitor, and a third capacitor, said resonant circuit configured to generate an alternating voltage between said inductor and said third capacitor,
b) a LED light source parallel loaded to said resonant circuit configured to receive said alternating voltage and generate light.

30. The lighting ballast of claim 29 wherein the non-electrolytic capacitor is of a value which does not filter a voltage component at the line frequency of the rectified AC voltage.
